(19) United States
(12) Patent Application Publication
(10) Pub. No.: US 2024/0132651 A1
(43) Pub. Date: Apr. 25, 2024

(54) REACTIVE FUNCTIONALIZATION OF CARBON-CARBON BACKBONE POLYMERS AND RELATED COMPOSITIONS

(71) Applicant: BOARD OF TRUSTEES OF MICHIGAN STATE UNIVERSITY, East Lansing, MI (US)

(72) Inventors: Muhammad Rabnawaz, East Lansing, MI (US); Muhammad Naveed, East Lansing, MI (US)

(21) Appl. No.: 18/278,200

(22) PCT Filed: Feb. 22, 2022
(86) PCT No.: PCT/US22/17206

§ 371 Date: Aug. 21, 2023

Related U.S. Application Data
(60) Provisional application No. 63/151,880, filed on Feb. 22, 2021.

(51) Int. Cl. C08F 299/00; C08F 255/02; C08L 23/06

(52) U.S. Cl. CPC C08F 299/00; C08F 255/023; C08L 23/06; C08F 2438/02; C08L 2205/025; C08L 2205/03; C08L 2205/08; C08L 2207/062

(57) ABSTRACT

The disclosure relates to the functionalization of a carbon-carbon backbone (CCB) polymer using a (cyclic) grafting agent, an initiator, and optionally a reversible radical trapping agent. The grafting agent and/or initiator can be particularly selected in terms of their surface energy and/or half-life, respectively, to limit or control undesirable effects associated with reactive melt-processing, such as excessive crosslinking, chain scission, or grafting agent homopolymerization, as well as to improve or control desirable effects associated with reactive melt-processing, such as improved relative graft uniformity or homogeneity on the CCB polymer. In some cases, the grafting agent can further include a functional group to impart some additional or new chemical or physical property to the CCB polymer. In some cases, the reactively melt-processed mixture includes two or more different polymers that are compatibilized via the grafting agent.

### CROSS REFERENCE TO RELATED APPLICATION

Priority is claimed to U.S. Provisional Application No. 63/151,880 filed on Feb. 22, 2021, which is incorporated herein by reference in its entirety.

### STATEMENT OF GOVERNMENT INTEREST

None.

### BACKGROUND OF THE DISCLOSURE

### Field of the Disclosure

The disclosure relates to the functionalization of a carbon-carbon backbone (CCB) polymer using a (cyclic) grafting agent, an initiator, and optionally a reversible radical trapping agent. The grafting agent and/or initiator can be particularly selected in terms of their surface energy and/or half-life, respectively, to limit excessive crosslinking, chain scission, or grafting agent homopolymerization, as well as to improve graft uniformity.

### Brief Description of Related Technology

Carbon-carbon backbone (CCB) polymers, including polyolefins (POs) (such as polyethylene (PE) and polypropylene (PP)) and polystyrenes (PSs), make up a substantial share of global polymers production, with estimated annual production of >250 million tons. PE and PP are particularly widespread, together accounting for over 60% of all polymers. However, many CCB polymers lack polar groups or other functional groups, rendering them unfit for a wide range of applications. Accordingly, methods of obtaining functionalized CCB polymers, such as methods involving direct polymerization or post-polymerization functionalization, are of interest. Furthermore, as plastic recycling rates are generally low, a consequence of widespread polymer production and use is growing accumulation of waste plastics. Thus, post-polymerization functionalization methods that can be used to convert waste plastics, particularly waste CCB polymers such as polyolefins, into functional materials are of substantial practical interest.

Methods of synthesizing functionalized CCB polymers are known in the art. FIG. 1 illustrates several such methods. For instance, ROMP (ring-opening metathesis polymerization) and ADMET (acyclic diene metathesis polycondensation) can be used to synthesize functionalized polyolefins directly from cyclic olefin or diene precursors, respectively. However, these methods can require expensive precursors and are generally not suitable for functionalization of waste plastics. Direct copolymerization of olefinic monomers, particularly ethylene or propylene, with functional monomers such as acrylates is often ineffective due to poor reactivity between the different types of monomers; functional monomers can have a higher tendency to homopolymerize rather than to copolymerize with ethylene or propylene, leading to low functionalization yield and inhomogeneous functionalization. Introduction of a catalyst can improve direct polymerization routes, though this approach brings added cost. Furthermore, direct copolymerization methods are not applicable to functionalization of waste plastics.

Post-functionalization methods can also be used to access functionalized CCB polymers, as illustrated in FIG. 1. In particular, reactive extrusion (REX) can be used to functionalize polymers, including but not limited to polyolefins or other CCB polymers. In a typical REX functionalization process, virgin or used polymer(s) and one or more additives are melted in an extruder under conditions suitable to initiate a desired reaction to achieve functionalization of the polymer(s). REX processing generally does not require a solvent, reducing environmental and throughput concerns associated with solvent-based functionalization methods. REX processing can be performed under conditions that generate free radicals which can break C—H bonds on the polymer and initiate functionalization.

While REX is a useful functionalization method, it is not without challenges. FIG. 2 lists several challenges associated with REX functionalization of CCB polymers. For instance, the efficiency of functionalization achieved by REX can be low if the CCB polymer and functionalizing agents are poorly miscible. Compensating for this deficiency by, for instance, increasing the level of functionalizing agent also increases cost and increases the likelihood that the functionalizing agent will undergo homopolymerization. The CCB polymer can also be subject to side reactions, particularly chain scission and cross-linking, that can impact functionality of the resulting product. Techniques that can overcome the challenges of REX processing and enable more complete, efficient, and homogeneous functionalization of polymers are therefore of interest.

### SUMMARY

In one aspect, the disclosure relates to a method for functionalizing a carbon-carbon backbone (CCB) polymer, the method comprising: reactive melt-processing a mixture comprising (i) a carbon-carbon backbone (CCB) polymer, (ii) a (cyclic) grafting agent selected from the group consisting of unsaturated cyclic anhydrides (e.g., maleic anhydride), unsaturated cyclic imides (e.g., maleimide), ring-opened analogs thereof, and combinations thereof, (iii) an initiator (e.g., peroxide), and (iv) optionally a reversible radical trapping agent, thereby forming a functionalized CCB polymer comprising the CCB polymer and the grafting agent. The functionalized CCB polymer reaction product can include polymer chains with radical-addition-product linkages between the grafting agent and the (original) CCB polymer chains. Improved melt processability and control of the grafting/functionalization reaction can be achieved when at least one of the following conditions (A), (B), and (C) apply to the reactive melt-processing: (A) the grafting agent has a surface energy relative to that of the CCB polymer in a ratio in a range from 0.02 to 2.0 (or “surface energy ratio”); (B) a ratio of a half-life of the initiator relative to a residence time for the reactive melt-processing is in a range of 0.2 to 5.0 (or “half-life ratio”); or (C) the reversible radical trapping agent is present in the reactively melt-processed mixture. In various embodiments, only one, only two, or all three conditions apply, for example conditions (A) and (B) apply (e.g., but not (C)), conditions (A) and (C) apply (e.g., but not (B)), conditions (B) and (C) apply (e.g., but not (A)), or all three conditions (A)-(C) apply. The CCB polymer can include common thermoplastics such as polyolefins (e.g., polyethylene (PE) and/or polypropylene (PP)) or polystyrenes (PS), but it more generally can include other polymers with a substituted or unsubstituted carbon-carbon backbone, such as ABS (acrylonitrile-butadiene-styrene). Suitable reversible radical trapping agents can include cyclic nitroxides such as unsubstituted or substituted TEMPO compounds.

The grafting agent can include unsaturated cyclic anhydrides, unsaturated cyclic imides, and ring-opened analogs such as substituted or unsubstituted maleic anhydride, or a substituted or unsubstituted maleimide. The grafting agent can include one compound or a mixture of compounds suitable for grafting, such as bismaleimide and maleic anhydride in combination. The disclosed functionalized CCB polymer is suitably formed using of a grafting agent like maleimide or maleic anhydride as compared to a vinyl or alkenyl analog (e.g., CH₂═CH—R, where R includes linking moieties and/or crosslinking moieties) to improve grafting and avoid homopolymerization as an important benefit of the disclosed methods and compositions. Accordingly, grafting agents according to the disclosure preferentially react via free-radical addition to the CCB polymer backbone instead of via self-polymerization.

In another aspect, the disclosure relates to a method for forming a carbon-carbon backbone (CCB) compatibilizer copolymer, the method comprising: (1) reactive melt-processing (i) a first carbon-carbon backbone (CCB) polymer, (ii) a first grafting agent selected from the group consisting of unsaturated cyclic anhydrides, unsaturated cyclic imides, ring-opened analogs thereof, and combinations thereof, (iii) a first initiator, and (iv) optionally a first reversible radical trapping agent, thereby forming a first functionalized CCB polymer comprising the first CCB polymer and the first grafting agent; wherein at least one of conditions (A1), (B1), and (C1) apply: (A1) the first grafting agent has a surface energy relative to that of the first CCB polymer in a ratio in a range from 0.02 to 2.0; (B1) a ratio of a half-life of the first initiator relative to a residence time for the reactive melt-processing is in a range of 0.2 to 5.0; or (C1) the first radical trapping agent is present; (2) reactive melt-processing (i) a second polymer, (ii) a second grafting agent selected from the group consisting of unsaturated cyclic anhydrides, unsaturated cyclic imides, ring-opened analogs thereof, and combinations thereof, (iii) a second initiator, and (iv) optionally a second reversible radical trapping agent, thereby forming a second functionalized polymer comprising the second polymer and the second grafting agent; wherein at least one of conditions (A2), (B2), and (C2) apply: (A2) the second grafting agent has a surface energy relative to that of the second polymer in a ratio in a range from 0.02 to 2.0; (B2) a ratio of a half-life of the second initiator relative to a residence time for the reactive melt-processing is in a range of 0.2 to 5.0; or (C2) the second radical trapping agent is present; and (3) reactive melt-processing the first functionalized CCB polymer and the second functionalized polymer, thereby forming a CCB compatibilizer copolymer comprising (segments of) the first CCB polymer and (segments of) the second polymer joined via the first grafting agent and the second grafting agent. The first CCB polymer and the second polymer (which can be a second CCB polymer) are different polymers. The first CCB polymer and the second polymer can be from a recycled polymer stream (e.g., scrap and/or post-consumer waste plastic, for example including one or more impurities or contaminants such as paper, silica, etc.). The first and second grafting agents, initiators, and radical trapping agents can be the same or different.

When forming the CCB compatibilizer copolymer, the reactive melt-processing steps can be performed in a single melt-processing apparatus (e.g., a single extruder) or in multiple melt-processing apparatus (e.g., multiple extruders).

For example, first and second functionalized CCB polymers can be prepared separately in two different extruders. Then, the first and second functionalized CCB polymers can be melt-blended with a coupling agent (e.g., diol, diamine, etc.) in a third extruder to form the CCB compatibilizer copolymer. The CCB compatibilizer can be used to compatibilize a blend of unmodified/non-functionalized first and second polymers using about 0.5-10 wt. % (e.g., at least 0.5, 1, 1.5, 2, or 3 wt. % and/or up to 3, 4, 6, 8, or 10 wt. %) compatibilizer copolymer relative to total unmodified/non-functionalized polymers (or the blend as a whole). For example, the first polymer can be PE, and the second polymer can be PP, both of which could be virgin or recycled (e.g., post-consumer and/or post-industrial) polymers.

Alternatively, first and second functionalized CCB polymers as well as the CCB compatibilizer copolymer can be formed in a single extruder. For example, the first functionalized CCB polymer can be formed at a first (inlet) portion of the extruder (e.g., feeding the first CCB polymer and grafting agent thereto), and the second functionalized CCB polymer can be formed at a second (downstream) portion of the extruder (e.g., feeding the second CCB polymer and additional grafting agent to the extruder at a downstream port). Then, at a third (further downstream) portion of the extruder, a coupling agent can be added to reactively melt-process the first and second functionalized CCB polymers, thereby forming the CCB compatibilizer copolymer. The CCB compatibilizer can be used to compatibilize a blend of unmodified/non-functionalized first and second polymers using about 0.5-10 wt. % (e.g., at least 0.5, 1, 1.5, 2, or 3 wt. % and/or up to 3, 4, 6, 8, or 10 wt. %) compatibilizer copolymer relative to total unmodified/non-functionalized polymers (or the blend as a whole).

In another illustrative embodiment, the first functionalized CCB polymer can be formed at a first (inlet) portion of a first extruder (e.g., feeding the first CCB polymer and grafting agent thereto), and the second functionalized CCB polymer can be formed at a first (inlet) portion of a second extruder (e.g., feeding the second CCB polymer and grafting agent thereto). Then, the second functionalized CCB polymer can be added along with a coupling agent to the first extruder at a second (downstream) portion of the first extruder, thereby forming the CCB compatibilizer copolymer.

In another illustrative embodiment, the first CCB polymer can be functionalized in a first extruder, and to this extruder another extruder line is connected where functionalized second CCB polymer is produced and added to the first extruder. Then, using a downstream feeder, coupling agents can be added to form the CCB compatibilizer copolymer by exposing the first and second CCB polymers to a single melt operation.

In another aspect, the disclosure relates to a method for compatibilizing a polymer blend, the method comprising: providing a CCB compatibilizer copolymer according to any of the variously disclosed embodiments or forming a CCB compatibilizer copolymer according to any of the variously disclosed embodiments; and melt-blending a mixture comprising a first polymer, a second polymer, and the CCB compatibilizer copolymer, thereby forming a compatibilized polymer blend; wherein the first polymer and the second polymer correspond to segments of the CCB compatibilizer copolymer (e.g., first CCB polymer and second CCB polymer; CCB polymer and further or second polymer). In another aspect, the disclosure relates to a compatibilized polymer blend comprising: a CCB compatibilizer copolymer according to its various embodiments and refinements; a first polymer, and a second polymer; wherein the first polymer and the second polymer correspond to segments of the CCB compatibilizer copolymer (e.g., first CCB polymer and second CCB polymer; CCB polymer and further polymer). The blend additionally can include third, fourth, etc. polymers. The first, second, third, fourth, etc. (CCB) polymers can from a recycled CCB polymer stream (e.g., scrap and/or post-consumer waste plastic, for example including one or more impurities or contaminants such as paper, silica, etc.). The CCB compatibilizer copolymer can present in an amount in a range of 0.1 wt. % to 10 wt. % (e.g., at least 0.1, 0.2, 0.5, 1, 1.5, 2, or 3 wt. % and/or up to 3, 4, 6, 8, or 10 wt. %) relative to the compatibilized polymer blend as a whole and/or relative to the polymers being compatibilized. The first polymer can be present in an amount in a range of 2 wt. % to 95 wt. % (e.g., at least 2, 5, 10, 15, 20, 30, 40, 50, 60, or 70 wt. % and/or up to 15, 20, 25, 35, 45, 55, 65, 75, 85, or 95 wt. %) relative to the compatibilized polymer blend. The second polymer can be present in an amount in a range of 2 wt. % to 95 wt. % (e.g., at least 2, 5, 10, 15, 20, 30, 40, 50, 60, or 70 wt. % and/or up to 15, 20, 25, 35, 45, 55, 65, 75, 85, or 95 wt. %) relative to the compatibilized polymer blend. Similar ranges can apply to any third, fourth, etc. additional polymers in the blend being compatibilized. Total polymers in the blend being compatibilized (e.g., first, second, third, fourth, etc. polymers combined, but not the CCB compatibilizer copolymer(s)) can be at least 80, 55, 90, 92, 94, 96, or 98 wt. % and/or up to 90, 95, 97, 99, or 99.5 wt. % relative to the compatibilized polymer blend.

In another aspect, the disclosure relates to a functionalized carbon-carbon backbone (CCB) polymer formed by any of the methods disclosed herein according to their various embodiments and refinements.

In another aspect, the disclosure relates to a carbon-carbon backbone (CCB) compatibilizer copolymer formed by any of the methods disclosed herein according to their various embodiments and refinements.

In another aspect, the disclosure relates to a functionalized carbon-carbon backbone (CCB) polymer comprising: a free-radical-initiated reaction product between a (i) a carbon-carbon backbone (CCB) polymer and (ii) a grafting agent selected from the group consisting of unsaturated cyclic anhydrides, unsaturated cyclic imides, ring-opened analogs thereof, and combinations thereof. The CCB polymers and grafting agents can have the same embodiments as and refinements as described herein for the corresponding method and its reaction product.

In another aspect, the disclosure relates to a carbon-carbon backbone (CCB) compatibilizer copolymer comprising: a free-radical-initiated reaction product between a (i) a carbon-carbon backbone (CCB) polymer, (ii) a further polymer, and (iii) a grafting agent selected from the group consisting of unsaturated cyclic anhydrides, unsaturated cyclic imides, ring-opened analogs thereof, and combinations thereof; wherein the CCB compatibilizer copolymer comprises (segments of) the CCB polymer and (segments of) the further polymer joined via the grafting agent. The CCB polymers, further polymers, and grafting agents can have the same embodiments as and refinements as described herein for the corresponding method and its reaction product.

Various refinements of the disclosed methods, functionalized carbon-carbon backbone (CCB) polymers, and carbon-carbon backbone (CCB) compatibilizer copolymers are possible.

In a refinement, the CCB polymer comprises a polyolefin, for example a mixture of two of more different polyolefins. The CCB polymer more generally includes any polymer with a —[C—C]ₙ— backbone and/or (only) —[C—C]— repeat units. For example, the CCB polymer can include —[—CR₂—CR₂—]— repeat units where the R groups on the backbone independently can be hydrogen atoms, alkyl groups, aromatic groups, or other substituents). Examples of CCB polymers include polyolefins and polystyrenes, for example as homopolymers or copolymers, for example including at least one olefin or styrene comonomer and at least one other comonomer including a vinyl reactive group (e.g., another olefin, another styrene, acrylonitrile or a different vinyl-containing monomer).

The polyolefin is not particularly limited and can include polymers (e.g., homopolymers, copolymers) formed from olefinic or alkene monomers (e.g., alpha-olefin monomers) such as ethene, propene, 1-butene, 1-pentene, 1-hexene, etc., which are typically used in a variety of commodity thermoplastic materials. Common thermoplastic polyolefins can include polyethylenes (PE) such as high-density polyethylene (HDPE), low-density polyethylene (LDPE), linear low-density polyethylene (LLDPE), very-low-density polyethylene (VLDPE), ultra-low-density polyethylene (ULDPE), or medium-density polyethylene (MDPE), polypropylene (PP), polymethylpentene (PMP), polybutene-1 (PB-1), ethylene-octene copolymers, stereo-block PP, olefin block copolymers, propylene-butane copolymers, metallocene polymers, etc. Examples of common polyolefin elastomers include polyisobutylene (PIB), poly(alpha-olefins), ethylene propylene rubber (EPR), ethylene propylene diene monomer (M-class) rubber (EPDM rubber), etc. In some embodiments, the polyolefin can be from a recycled and/or an otherwise post-consumer or post-industrial polyolefin feedstock. For example, the polyolefin can be a recycled polyolefin containing at least 90, 95, 98, or 99 wt. % and/or up to 99 or 100 wt. % of PE (e.g., one or more types), PP, or PE and PP. In some embodiments, the polyolefin can be a pristine or newly formed feedstock that is transformed into a functionalized CCB polymer prior to its first industrial, consumer, engineering, etc. application. In some embodiments, the polyolefin can include homopolymers or copolymers of the foregoing monomers, such as block, random, or graft copolymers, for example including pendant groups along the carbon-carbon backbone of the CCB polymer or functionalized CCB polymer (e.g., oligo- or poly-styrene chains).

In a refinement, the reactively melt-processed mixture contains the CCB polymer in an amount in a range from 40 wt. % to 99 wt. %, 80 wt. % to 99 wt. %, or 90 wt. % to 98 wt. % relative to the mixture. Suitably, the CCB polymer accounts for at least 40, 60, 80, 85, 90, 92, or 95 wt. % and/or up to 50, 70, 80, 90, 92, 94, 96, 98, or 99 wt. % of the reactively melt-processed mixture. The foregoing ranges can apply to independently to a single CCB polymer in the mixture, or the combined amount of all CCB polymers and other polymers (when present). Similarly, in various embodiments, the combined amount of non-polymer components (e.g., grafting agent, initiator, reversible radical trapping agent (when present), and any included additives or fillers) accounts for at least 1, 2, 3, 5, or 7 wt. % and/or up to 4, 6, 8, 10, 12, 15, or 20 wt. % of the reactively melt-processed mixture.

In a refinement, condition (A) applies and the grafting agent has a surface energy relative to that of the CCB polymer in a ratio in a range from 0.02 to 2.0 (or “surface energy ratio”). More generally, the surface energy is suitably selected to be comparable in magnitude to that of the CCB polymer. For example, the surface energy ratio can be at least 0.02, 0.05, 0.1, 0.2, 0.3, 0.5, 0.7, 0.9, or 1.2 and/or up to 0.5, 0.8, 1.0, 1.1, 1.2, 1.4, 1.6, 1.8, or 2.0. Selection of the grafting agent surface energy in this way can improve the melt miscibility of the CCB polymer and the grafting agent. This can further improve graft uniformity and/homogeneity, providing a more consistent distribution or addition of the grafting agent to the CCB polymer backbone. This also can increase the likelihood that the CCB polymer and the grafting agent react with each other, which in turn reduces the relative amount of grafting agent-grafting agent reactions (e.g., undesirable homopolymerization or block formation) and reduces the relative amount of CCB polymer-CCB polymer reactions (e.g., undesirable crosslinking or chain extension/MW increase). When the relative surface energies are substantially different, the grafting agent to the CCB polymer tend to form a relatively more inhomogeneous or segregated melt structure, which can lead to undesirable homopolymerization, crosslinking, etc.

In some embodiments, an absolute surface energy (or surface energy difference) can be used in addition to or instead of condition (A) to reflect selection of the grafting agent to improve melt miscibility. For example, the absolute surface energy of the grafting agent and/or the (original) CCB polymer(s) can be in a range of 10-60 or 20-50 dyne/cm, for example at least 10, 15, 20, 25, 30, 35, or 40 dyne/cm and/or up to 30, 35, 40, 45, 50, 55, or 60 dyne/cm. By way of example, typical polyolefins such as PE and PP generally have an absolute surface energy of about 30 dyne/cm (e.g., 25-35 dyne/cm). Maleimide grafting agents can have an absolute surface energy of about 20-35 dyne/cm, for example when including one or more (alkyl) side chains to adjust the surface energy. Maleic anhydride grafting agents can have an absolute surface energy of about 40 dyne/cm or higher. In some embodiments, a surface energy difference between the grafting agent and/or the (original) CCB polymer(s) can be within 2, 5, 10, or 15 dyne/cm (e.g., the magnitude of the difference between the absolute surface energy of the grafting agent and the CCB polymer where either could be higher than the other, but within 2, 5, 10, or 15 dyne/cm from each other).

The surface energy can be determined by any suitable method known in the art. The most common way to measure surface energy is through contact angle experiments. In this method, the contact angle of a surface (e.g., formed from the CCB polymer, grafting agent, or functionalized CCB polymer) is measured with several liquids, usually water and diiodomethane. Based on the contact angle results and knowing the surface tension of the liquids, the surface energy can be calculated according to known methods.

In a refinement, at least 50% or at least 90% of the (original) grafting agent molecules are directly bound to the CCB polymer backbone in the functionalized CCB polymer. In various embodiments, at least 20, 30, 40, 50, 60, 80, 90, 95 or 98% and/or up to 50, 70, 90, 95, 99 or 100% of the grafting agent molecules are directly bound to the CCB polymer backbone. Alternatively or additionally, not more than 1, 2, 5, 10, 20, 30, 40, or 50% of the grafting agent molecules are bound to another grafting agent molecule, for example grafting agent-grafting agent bonding can represent the formation of a separate homopolymer or grafting agent block appended to the CCB polymer backbone, both of which are generally undesirable. More generally, the functionalized CCB polymer can be characterized as having an improved homogeneity or uniformity of the grafting agent bound to the CCB polymer instead of remaining unreacted and/or homopolymerized. Solvent extraction of the reaction product can be used to test if there is any grafting agent homopolymer or CCB polymers with heavily non-uniform grafting, for example via FTIR and NMR analysis of the grafted copolymer after solvent extraction. Crystallinity analysis of the reaction product also can be used to characterize grafting uniformity: A uniformly grafted reaction product will exhibit a new (single) melting temperature (Tₘ) distinct from that of the original CCB polymer, while non-uniform may exhibit multiple distinct melting temperatures corresponding to both the original CCB polymer and non-uniformly grafted functionalized CCB polymer.

In a refinement, the grafting agent comprises a 5-membered ring structure, a 6-membered ring structure, or a ring-opened analog thereof (e.g., a difunctional analog). The 5- and 6-membered ring structure can be unsaturated. The ring structure includes carbon atoms and typically also includes one or more N or O heteroatoms, for example 1, 2, or 3 N or O heteroatoms. For example, in some embodiments, the ring structure can include an unsaturated C═C bond that can participate in the free-radical grafting reaction between the grafting agent and the CCB backbone, such as in a maleic anhydride-based or maleimide-based grafting agent moiety. In other embodiments, the ring structure is saturated (e.g., including only C—C, C-heteroatom, or heteroatom-heteroatom single bonds in the ring), but it can include or exclude unsaturated C═C functional groups as part of the grafting agent. For example, a cyclic itaconic anhydride has a 5-membered saturated ring (with 4 carbon and 1 oxygen atoms), but it has a pendant C═C functional group that can participate in the free-radical grafting reaction.

In addition to the cyclic 5- and 6-membered ring structure, the grafting agent can include a ring-opened analog of the ring structure. For example, common ring structures of the grafting agent can include oxygen atoms as part of an anhydride group or nitrogen atoms as part of an imide group. In such cases, the ring-opened analog can include hydroxy, alkoxy, and/or amino groups at each of the ring-opened carbonyl atoms to provide two corresponding carboxylic, ester, or amide groups in the ring-opened analog. Such ring-opened analogs include two carbonyl carbon atoms joined by a linking group with 2 or 3 atoms (e.g., carbon atoms with optionally 1 or 2 N or O heteroatoms) and an unsaturated C═C bond (e.g., along/within the linking group pendant thereon). Illustrative ring and ring-opened analog structures are shown in FIG. 3, where the various R substituents can include alkyl and/or aryl groups with 1-12 or 2-6 carbon atoms. The top left structure can be maleic anhydride or derivative thereof (i.e., when X is O), or maleimide or derivative thereof (i.e., when X is NRY). The bottom left structure illustrates the ring-opened analog of the top left structure, with X and X′ representing the two carboxylic, ester, or amide groups in the ring-opened analog corresponding to the original anhydride or imide group, for example where X can further include or be substituted with a reactive group such as an epoxy, hydroxy, unsaturated, or carboxyl group. The bottom right structure similarly illustrates a ring-opened analog structure, but with X and X′ possibly including a reactive group. The top right structure can be difunctional grafting agent with two maleimide rings joined by a linking group such as R″-[linker]-R″ (e.g., alkyl linkers R″ such as the R groups above and an irreversible or reversible linker such as an ester or silyl ether) or a alkyl linking group between the two X groups (e.g., such as the R groups above). Although illustrated with a single possible R group ring substituent, either or both of the ring (unsaturated) carbon atoms can include an alkyl or aryl group substituent in place of hydrogen in the various illustrate ring and corresponding ring-opened structures.

In a refinement, the grafting agent comprises an unsaturated cyclic anhydride moiety. Suitable unsaturated cyclic anhydrides can include substituted and unsubstituted anhydrides of dicarboxylic acids containing a —C(═O)OC(═O)— group. Examples of suitable unsaturated cyclic anhydrides include maleic anhydride, itaconic anhydride, cis-glutaconic anhydride, citraconic anhydride, etc. A general unsaturated cyclic anhydride can be represented by R¹C(═O)OC(═O), where R¹ includes at least two atoms (e.g., carbon atoms) linking the two carbonyl carbon atoms in a cyclic structure and at least one (or only one) unsaturated C═C group as part of the cyclic structure, whether as part of the ring or pendant on the ring. For example, R¹ can have 2, 3, 4, 5, or 6 carbon atoms and optionally one or more N or O heteroatoms, for example 1, 2, or 3 N or O heteroatoms, which carbon and/or heteroatoms can be unsubstituted (with H) or substituted (with other than H). Suitably, 2, 3, 4, or 5 of the carbon and/or heteroatoms in R¹ can be those linking the two carbonyl carbon atoms in the cyclic structure. In some embodiments, R¹ can include a larger number of carbon atoms, for example up to 8, 10, 12, 15, or 20 carbon atoms, to adjust the surface energy of the cyclic anhydride for better surface energy-matching with the CCB polymer. As discussed above, the unsaturated C═C functional group that can participate in the free-radical grafting reaction with the CCB polymer backbone can be part of the cyclic ring structure (e.g., as in maleic anhydride) or pendant from the cyclic ring structure (e.g., as in itaconic anhydride). The unsaturated cyclic anhydrides are particularly useful because the unsaturated cyclic structure resists undesirable homopolymerization, instead favoring the desired free-radical addition reaction with the polyolefin backbone. The unsaturated cyclic anhydrides are also useful because hydrolysis and ring-opening of the anhydride by reaction with a polyol, polyepoxide, etc. can create both an ester bond with a pendant functional group or crosslinking group as well as a free carboxylic acid group. As discussed above, the cyclic grafting agent can include ring-opened analogs of its ring counterparts, such as an unsaturated diacid, diester, or diamide corresponding to the foregoing unsaturated cyclic anhydrides. For example, maleic acid as a ring-opened diacid analog to maleic anhydride could be used as a grafting agent that can graft to the CCB polymer backbone, react to form an ester bond as part of a pendant functional group or crosslinking group, and retain a free pendant acid group.

In a refinement, the grafting agent comprises an unsaturated cyclic imide moiety. Suitable unsaturated cyclic imides can include substituted and unsubstituted imides containing a —C(═O)NR²C(═O)— group. Examples of suitable unsaturated cyclic imides include maleimide and other imide analogs corresponding to an unsaturated cyclic anhydride (e.g., as described above) converted to an imide by reaction with a suitable amine (e.g., NH₂R²), etc. A general unsaturated cyclic anhydride can be represented by R¹C(═O)NR²C(═O), where R¹ includes at least two atoms (e.g., carbon atoms) linking the two carbonyl carbon atoms in a cyclic structure and at least one (or only one) unsaturated C═C group as part of the cyclic structure. R² can be a substituted or unsubstituted hydrocarbon or alkyl group, for example having 1 to 20 carbon atoms (e.g., at least 1, 2, 3, 4, 6, or 8 and/or up to 4, 6, 8, 10, 12, 15, or 20 carbon atoms), which can be unsubstituted or substituted with a hydroxy group, an epoxide group, etc. R¹ can have the same options as above for the unsaturated cyclic anhydrides. As discussed above, the unsaturated C═C functional group that can participate in the free-radical grafting reaction with the polyolefin backbone can be part of the cyclic ring structure (e.g., as in maleimide). The unsaturated cyclic imides are particularly useful because the unsaturated cyclic structure resists undesirable homopolymerization, instead favoring the desired free-radical addition reaction with the polyolefin backbone. The unsaturated cyclic imides are also useful because the pendant R² group in the imide can include a functional group or a linking group, for example a hydrocarbon linker with another cyclic imide group. More generally, imides such as maleimide can bear functional groups such as OH (e.g., as in N-(2-hydroxyethyl)maleimide), COOH (e.g., as in 6-maleimidohexanoic acid), epoxy (e.g., as in N-(2-epoxyethyl)maleimide), and unsaturated carbon-carbon group (C═C), etc., for example in the R² group. As discussed above, the grafting agent can include ring-opened analogs of its ring counterparts, such as an unsaturated diacid, diester, or diamide corresponding to the foregoing unsaturated cyclic imides.

In a refinement, the grafting agent further comprises a pendant functional group selected from the group consisting of a silyl ether, a further unsaturated carbon-carbon group (C═C), a hydroxy group, a carboxylate group, an epoxide (or oxirane) group, an amino group, an ester group, and combinations thereof. The functional groups appended to the CCB polymer via the grafting agent are not particularly limited, but they can be selected to impart some additional or new chemical or physical property to the CCB polymer. In some embodiments, the functional group does not promote crosslinking of the CCB polymer, for example when the grafting agent is monofunctional with respect to its reactive unsaturated group and the pendant functional group is not reactive with the CCB polymer or other components of the reactively melt-processed mixture. The pendant functional group can be bound or otherwise appended to the grafting agent at any suitable position, for example at a ring nitrogen atom in a malemide or other cyclic grafting agent, at a ring unsaturated carbon in a malemide, maleic anhydride, or other cyclic grafting agent, at a carbonyl-containing group (e.g., an ester or amide group) in a ring-opened maleic anhydride, etc.

In a refinement, the grafting agent contains at least two (e.g., only two) unsaturated groups. The grafting agent can include two or more unsaturated groups to provide some low degree of branching and/or crosslinking in the original CCB polymer, which can be useful to compatibilize a mixture of different CCB polymers (e.g., a blend of different polyolefins in a recycled plastic waste stream) and/or help to maintain or control the molecular weight of the CCB polymer(s). Suitably the grafting agent includes only two unsaturated groups in such embodiments to limit potentially excessive crosslinking. Grafting agents with multiple unsaturated groups can be formed from two or more of the above 5-membered ring structures, a 6-membered ring structures, or corresponding ring-opened analogs joined together by a suitable linking group. For example, two maleimide rings can be joined by a suitable linking group between their respective ring nitrogen atoms (e.g., formed via diamine reaction with maleic anhydride) to form a corresponding difunctional maleimide. Similarly, two ring-opened maleic anhydride rings can be joined by a linking group between respective ester groups (e.g., formed by ring-opening diol reaction with maleic anhydride) to form a corresponding difunctional ring-opened maleic anhydride.

In a refinement, the reactively melt-processed mixture comprises at least two different CCB polymers. For example, the reactively melt-processed mixture can comprise polyethylene as a first CCB polymer and polypropylene as a second CCB polymer. In some cases, the reactively melt-processed mixture includes two or more different CCB polymers (e.g., from a recycled waste plastic source/stream) that are compatibilized via the grafting agent (e.g., with or without any additional functional group). A difunctional grafting agent (e.g., bismaleimide) can promote compatibilization by joining fragments or other radical-containing analogs of the different CCB polymers formed during reactive melt-processing via the difunctional grafting agent. A monofunctional grafting agent (e.g., maleic anhydride, maleic acid) can similarly promote compatibilization when a coupling agent is added to the reactively melt-processed mixture. Di- or otherwise poly-functional coupling agents such diols, diamines, diepoxies, etc. can react to form ester or amide links between ring-opened anhydride monofunctional grafting agents (e.g., forming a difunctional grafting agent in situ during reactive melt-processing). For example, an initial blend of two polymers P₁ (e.g., PE) and P₂ (e.g., PP) melt-processed according to the disclosure can form a P₁/P₂ copolymer formed from a portion of the original P₁ and P₂ polymers joined via the grafting agent, while a portion of the original P₁ and P₂ polymers remain in their original form (or at least not copolymerized with the other polymer). The P₁/P₂ copolymer, having structures in common with the original P₁ and P₂ polymers serves to compatibilize the blended mixture.

In a further refinement, the CCB polymer in the reactively melt-processed mixture comprises a first CCB polymer and a second CCB polymer; and the functionalized CCB polymer comprises a CCB compatibilizer copolymer comprising (segments of) the first CCB polymer and (segments of) the second CCB polymer joined via the grafting agent. The grafting agent can be a monofunctional grafting agent; the reactively melt-processed mixture can further comprise a coupling agent; and the CCB compatibilizer copolymer can comprise coupling agent links between the first CCB polymer and the second CCB polymer. The reactively melt-processed mixture can further comprise at least one of the first CCB polymer, the second CCB polymer, functionalized first CCB polymer, and functionalized second CCB polymer. The first CCB polymer and the second CCB polymer can be from a recycled CCB polymer stream (e.g., scrap and/or post-consumer waste plastic, for example including one or more impurities or contaminants such as paper, silica, etc.).

In a refinement, the reactively melt-processed mixture comprises a further polymer. The further polymer can be another CCB polymer, such that the mixture contains two or more different CCB polymers. The further polymer can be other than a CCB polymer, such that the mixture contains at least one CCB polymer and at least one non-CCB polymer. Examples of suitable non-CCB polymers include various condensation polymers such as polyesters (e.g., polyethylene terephthalate (PET), poly(lactic acid) (PLA), etc.), polyamides (e.g., various nylon grades), and other thermoplastics. Thus, as similarly described above, the reactively melt-processed mixture can includes two or more different polymers (e.g., from a recycled waste plastic source/stream) that are compatibilized via the grafting agent (e.g., with or without any additional functional group). A difunctional grafting agent or monofunctional grafting agent in combination with a coupling agent can be used as described above. Examples of multi-component/multi-polymer systems that can be compatibilized include (1) two or more of HDPE, LDPE, LLDPE, and PP (with or without other impurities); (2) two or more of HDPE, LDPE, LLDPE, PP, and PS (with or without other impurities); (3) two or more of LDPE, LLDPE, and PP (with or without other impurities); (4) two or more of LDPE, LLDPE, PP, and PS (with or without other impurities); and (5) one or more of HDPE, LDPE, LLDPE, PP, and PS with one or more condensation polymers (e.g., PET, PLA, nylon). Any of the foregoing multi-component/multi-polymer systems can further include one or more fillers such as silica, carbon fibers, glass fibers, etc.

In a further refinement, the functionalized CCB polymers can be used for the compatibilization of a binary mixed plastics system (virgin, post-industrial, post-consumer or combination) comprised of (i) a CCB polymer and another CCB polymer as well as (ii) a CCB polymer and a condensation polymer such as PP/PE, PP/PS, PE/PS, PE/PET, PET/PP, PE/PLA, etc. In a further refinement, the functionalized CCB polymers can be used to for the compatibilization of ternary mixed plastics system (virgin, post-industrial, post-consumer or a combination) comprised of (i) all CCB polymers, or (ii) a combination of at least one CCB polymer and at least one condensation polymer such as PP/PE/PS, PP/PE/PET, etc. In a further refinement, the functionalized CCB polymers can be used to for the compatibilization of quaternary and even higher blends mixed plastics system (virgin, post-industrial, postconsumer or combination) comprised of (i) all CCB polymers, or (ii) a combination of at least one CCB polymer and at least one condensation polymer such as PP/PE/PS/PET, PP/PE/PS/ABS, etc. In certain embodiments, the compatibilization can be combined with polymer processing methods such as drawing, fibers/fillers, and/or waste fibers (such as from old newspaper) to achieve desirable properties. In certain embodiments, the cyclic grafting agents can be used along with other vinyl/allyl compounds such as allyl trimethoxy silane, allyl triethoxy silane, other alkoxy silanes, etc, for the functionalization of CCB polymers. In certain embodiments, the compatibilization can be used for LLDPE/LDPE and PP mixed plastics (virgin, post-industrial, postconsumer). In certain embodiments, complex multiple packages made of all polyolefins, or polyolefins and condensation polymers can be compatibilized by this approach.

In a further refinement, the functionalized CCB polymer comprises a CCB compatibilizer copolymer comprising (segments of) the CCB polymer and (segments of) the further polymer joined via the grafting agent. The grafting agent can be a monofunctional grafting agent; the reactively melt-processed mixture can further comprise a coupling agent; and the CCB compatibilizer copolymer can comprise coupling agent links between the CCB polymer and the further polymer. The further polymer can be selected from the group consisting of high-density polyethylene (HDPE), low-density polyethylene (LDPE), linear low-density polyethylene (LLDPE), polypropylene (PP), polystyrene (PS), polyethylene terephthalate (PET), polylactic acid (PLA), polyamides, and combinations thereof; and the further polymer is different from the CCB polymer (but can be a CCB polymer itself). The reactively melt-processed mixture can further comprise at least one of the CCB polymer, the further polymer, functionalized CCB polymer, and functionalized further polymer. The CCB polymer and the further polymer can be from a recycled CCB polymer stream (e.g., scrap and/or post-consumer waste plastic, for example including one or more impurities or contaminants such as paper, silica, etc.).

In a refinement, the melt-processed mixture contains the grafting agent in a range from 0.5 wt. % to 50 wt. % relative to the CCB polymer. The amount of the grafting agent is not particularly limited and can be selected based on the desired level of functionalization in the final functionalized CCB polymer. For example, the melt-processed mixture can include one or more grafting agents in an amount of at least 0.5, 1, 2, 5, 10, 15, 20, or 30 wt. % and/or up to 2, 3, 5, 7, 10, 12, 15, 25, 35, or 50 wt. % relative to the CCB polymer.

In a refinement, the initiator comprises a peroxide free-radical initiator. The initiator is not particularly limited and can include free-radical initiators known in the art, for example organic peroxides, inorganic peroxides, and azo compounds. Example peroxide free-radical initiators include di(tert-butylperoxy)-3,3,5-trimethylcyclohexane and dicumyl peroxide, 2,5-bis(tert-butylperoxy)-2,5-dimethylhexane (e.g., LUPEROX 101), 1,1-bis(tert-butylperoxy)-3,3,5-trimethylcyclohexane 92% (LUPEROX 231), tert-butyl hydroperoxide, tert-butyl peracetate, benzoyl peroxide, di-tert-butyl peroxide, di-isobutyl peroxide, etc. While one can choose from the any know free-radical intiator sources, more preferable are those initiators that have a half-life of about 1 to 20 minutes at elevated temperatures, for example at reactive melt-processing temperatures such as above 100° C. The initiator is suitably added to the reactive melt-processing mixture in an amount of 0.01-10 wt. % or 0.1-1 wt. % (e.g., based on the CCB polymer). The initiator can remain in residual corresponding amounts in the functionalized CCB polymer product.

In a refinement, condition (B) applies and the ratio of a half-life of the initiator relative to a residence time for the reactive melt-processing is in a range of 0.2 to 5.0 (or “half-life ratio”). The initiator half-life is suitably selected to be comparable in magnitude to the residence time for the reactive melt-processing process, for example whether reactive extrusion or otherwise. In general, the half-life is the time required to reduce the original initiator content of a solution by 50%, at a given temperature. For example, for a peroxide initiator, the half-life can represent time required for half of the existing ROOR initiator molecules to decompose to corresponding RO· radicals that can initiate free-radical addition at a given temperature. The residence time can be determined as generally known in the art for reactive systems, for example being expressed as a ratio of the internal volume of the reactive melt processing apparatus (e.g., extruder) relative to the volumetric rate or throughput of polymer for the apparatus). Selection of the initiator half-life in this way can provide a relatively slower, more controlled release of initiator radical in a way that reduces undesirable molecular weight losses (e.g., via chain scission) and/or crosslinking while still promoting the desired free-radical-initiated reaction between the CCB polymer and the cyclic grafting agent. In various embodiments, the half-life ratio can be at least 0.2, 0.4, 0.6, 0.8, 0.9, 1.0, 1.2, 1.5, or 2 and/or up to 0.5, 0.7, 1, 1.1, 1.2, 1.4, 1.6, 1.8, 2.0, 2.5, 3.0, 4.0, or 5.0. Additionally or alternatively (i.e., independent of whether condition (B) applies), the initiator can be selected to have a half-life of 1-20 minutes or 3-10 minutes at the reactive melt-processing temperature (e.g., maximum temperature for a variable-temperature process), for example at least 1, 2, 3, 4, 5, 7, or 9 minutes and/or up to 2, 4, 6, 8, 10, 12, 15, or 20 minutes. Additionally or alternatively (i.e., independent of whether condition (B) applies), the reactive melt-processing operating conditions can be selected to have a residence time of 1-20 minutes or 3-10 minutes, for example at least 1, 2, 3, 4, 5, 7, or 9 minutes and/or up to 2, 4, 6, 8, 10, 12, 15, or 20 minutes.

In a refinement, condition (C) applies and the reversible radical trapping agent is present in the reactively melt-processed mixture. The radical trapping agent can reversibly bond/de-bond with polymer chain radicals (e.g., represented by —CH₂—CH(·)—CH₂—) generated during reactive melt-processing via the initiators. Such reversible bonding/de-bonding can limit the available polymer chain radical sites that might otherwise result in undesirable crosslinking and/or excessive molecular weight increase (e.g., as can happen with PE in other processes), or undesirable chain scission and/or excessive molecular weight decrease (e.g., as can happen with PP in other processes). The radical trapping agent is included in a suitable amount so that at least some available polymer chain radical sites remain for reaction between the CCB polymer and the cyclic grafting agent.

In a particular refinement, the reversible radical trapping agent comprises a cyclic nitroxide. In addition to cyclic nitroxides, other reversible radical-bonding compounds can be used, for example sulfur compounds such as dithiocarbamyl compounds. The radical trapping agent can be a cyclic nitroxide such as substituted or unsubstituted (2,2,6,6-tetramethylpiperidin-1-yl)oxidanyl (“TEMPO”). The cyclic TEMPO nitroxide has a 6-membered saturated ring (with 5 carbon and 1 nitrogen atoms) that can be free from pendant C═C functional groups, but its N—O nitroxide group as part of the TEMPO ring can reversibly react with the CCB polymer backbone. The radical trapping agent, for example a cyclic nitroxide or otherwise, can be used to increase grafting efficiency of the grafting agents (e.g., unsaturated cyclic anhydrides or imides). In addition to the TEMPO group, the cyclic nitroxide more generally can include any nitroxide radical that does not itself initiate any free radical polymerization of the monomer. In some embodiments, the nitroxide can be TEMPO (i.e., a 6-membered ring). In other embodiments, the nitroxide can be in a structure without a ring, but still with an N—O group (i.e. radical on oxygen atom) In the illustrative structure below, the R groups can independently have 2-12 carbon atoms as separate groups or collectively have 2-12 carbon atoms in a cyclic aliphatic structure (e.g., as in TEMPO).

In a particular refinement, the melt-processed mixture contains the reversible radical trapping agent in a range from 0.01 wt. % to 10 wt. % or 0.5 wt. % to 2 wt. % relative to the CCB polymer. For example, the melt-processed mixture can include one or more reversible radical trapping agents in an amount of at least 0.01, 0.1, 0.2, 0.5, 1, 1.5, or 2 wt. % and/or up to 0.5, 1, 2, 3, 5, 7, or 10 wt. % relative to the CCB polymer.

In a refinement, a molecular weight ratio of the functionalized CCB polymer relative to that of the CCB polymer is in a range from 0.2 to 3 or 0.5 to 1.5. The molecular weight ratio represents a final/initial ratio of molecular weight values to reflect that excessive chain scission and/or crosslinking does not occur such that the final molecular weight of the functionalized CCB polymer is desirably close to the initial molecular weight of the (original) CCB polymer. The molecular weight values used to determine the molecular weight ratio can represent weight- or number-average molecular weight values. In various embodiments, the molecular weight ratio can be at least 0.2, 0.3, 0.5, 0.7, 0.8, 0.9, 1, or 1.1 and/or up to 0.6, 0.8, 1, 1.1, 1.2, 1.4, 1.7, 2, 2.5, or 3.

In a refinement, the melt-processed mixture further comprises an additive selected from the group consisting of rheology modifiers, co-agents, fillers, and combinations thereof. Examples of rheology modifiers include waxes, plant oils, low-MW (molecular weight) polyolefins, and low-MW linear polyesters and polyolefins. Suitable MW ranges for such rheology modifiers include 200-5000 g/mol, and the rheology modifiers remain in admixture with the final CCB polymer (i.e., they are generally non-reactive). Example co-agents include donor molecules such as N,N′-ethylenebis(stearamide), dimethyl formamide (DMF), dimethyl acetamide, to suppress crosslinking in PE and suppress chain scission in PP. Butylated hydroxytoluene (BHT) or dithiocarbamyl can be used as a co-agent to increase grafting density. Suitable fillers includes silica, fibers such as carbon fibers, glass fibers, etc. The additives can be included individually or collectively in an amount of 0.01-20 wt. %, 0.1-10 wt. %, or 1-5 wt. %, relative to the weight of the CCB polymer or functionalized CCB polymer.

In a refinement, reactive melt-processing the mixture comprises reactively extruding the mixture. Any apparatus typically used for melt-processing of the CCB polymers may be used, for example twin- and single-screw extrusion apparatus operated at a sufficiently high temperature to melt the base CCB polymer material.

In a refinement, the method further comprises: reactive melt-processing a second mixture comprising (i) a further polymer, (ii) a grafting agent selected from the group consisting of unsaturated cyclic anhydrides, unsaturated cyclic imides, ring-opened analogs thereof, and combinations thereof, (iii) an initiator, and (iv) optionally a reversible radical trapping agent, thereby forming a functionalized further polymer comprising the further polymer and the grafting agent; wherein at least one of conditions (A), (B), and (C) apply: (A) the grafting agent has a surface energy relative to that of the further polymer in a ratio in a range from 0.02 to 2.0; (B) a ratio of a half-life of the initiator relative to a residence time for the reactive melt-processing is in a range of 0.2 to 5.0; or (C) the radical trapping agent is present in the reactively melt-processed mixture; and reactive melt-processing the functionalized CCB polymer and the functionalized further polymer, thereby forming a CCB compatibilizer copolymer comprising (segments of) the CCB polymer and (segments of) the further polymer joined via the grafting agent.

In a further refinement, the grafting agent is a monofunctional grafting agent; the functionalized CCB polymer and the functionalized further polymer are reactively melt-processed with a coupling agent; and the CCB compatibilizer copolymer comprises coupling agent links between the CCB polymer and the further polymer. The further polymer can be selected from the group consisting of high-density polyethylene (HDPE), low-density polyethylene (LDPE), linear low-density polyethylene (LLDPE), polypropylene (PP), polystyrene (PS), polyethylene terephthalate (PET), polylactic acid (PLA), polyamides, and combinations thereof; and the further polymer is different from the CCB polymer. The further polymer can comprise a further CCB polymer different from the CCB polymer.

While the disclosed articles, apparatus, methods, and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 lists synthetic and post-polymerization approaches for producing functionalized CCB polymers.

FIG. 2 lists challenges typically encountered with REX processing of CCB polymers and describes the approaches disclosed herein for overcoming these challenges.

FIG. 3 illustrates grafting agents featuring ringed and ring-opened structures.

FIG. 4 illustrates the impact on REX functionalization of a CCB polymer of using a grafting agent whose surface energy is poorly matched (A) or well-matched (B) to the surface energy of the polymer.

FIG. 5 illustrates the use of a multifunctional grafting agent such as a bis(maleimide) in REX processing of PE/PP to generate branched polymer structures while minimizing chain scission.

FIG. 6 illustrates the general structure of nitroxide-based compounds which can be useful as radical trapping agents in reactive extrusion processes according to the disclosure.

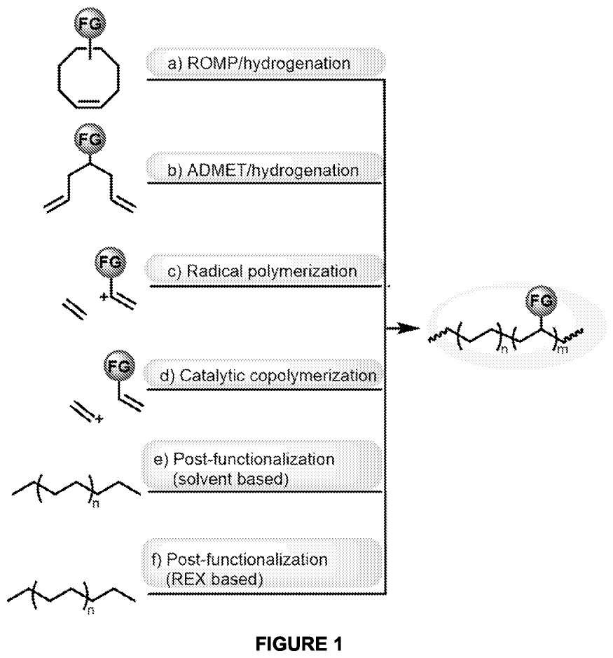

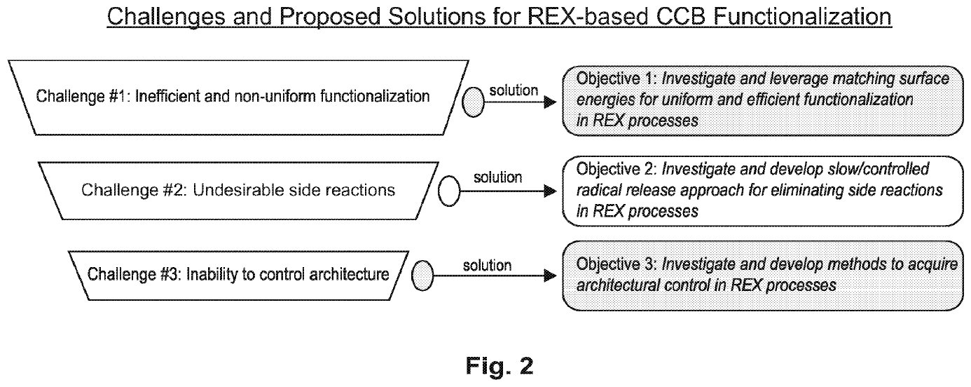

### DETAILED DESCRIPTION

The disclosure relates to the functionalization of a carbon-carbon backbone (CCB) polymer using a (cyclic) grafting agent, an initiator, and optionally a reversible radical trapping agent. The grafting agent and/or initiator can be particularly selected in terms of their surface energy and/or half-life, respectively, to limit or control undesirable effects associated with reactive melt-processing, such as excessive crosslinking, chain scission, or grafting agent homopolymerization, as well as to improve or control desirable effects associated with reactive melt-processing, such as improved relative graft uniformity or homogeneity on the CCB polymer.

In particular, the disclosure relates to a method for functionalizing a carbon-carbon backbone (CCB) polymer by reactive melt-processing. The method includes mixing a carbon-carbon backbone (CCB) polymer; a grafting agent, such as an unsaturated cyclic anhydride (e.g., maleic anhydride), an unsaturated cyclic imide (e.g., maleimide), or the ring-opened analogs of these species; an initiator, such as a peroxide; and optionally a reversible radical trapping agent, under conditions suitable for forming a functionalized CCB polymer comprising the CCB polymer and the grafting agent. The functionalized CCB polymer reaction product can include polymer chains with radical-addition-product linkages between the grafting agent and the (original) CCB polymer chains. Improved melt processability and control of the grafting/functionalization reaction can be achieved when at least one of the following conditions (A), (B), and (C) apply to the reactive melt-processing: (A) the grafting agent has a surface energy relative to that of the CCB polymer in a ratio in a range from 0.02 to 2.0 (or “surface energy ratio”); (B) a ratio of a half-life of the initiator relative to a residence time for the reactive melt-processing is in a range of 0.2 to 5.0 (or “half-life ratio”); or (C) the reversible radical trapping agent is present in the reactively melt-processed mixture. Only one, only two, or all three conditions can apply, for example, conditions (A) and (B) apply (e.g., but not (C)), conditions (A) and (C) apply (e.g., but not (B)), conditions (B) and (C) apply (e.g., but not (A)), or all three conditions (A)-(C) apply. The CCB polymer can include common thermoplastics such as polyolefins (e.g., polyethylene (PE) and/or polypropylene (PP)) or polystyrenes (PS), but it more generally can include other polymers with a substituted or unsubstituted carbon-carbon backbone, such as ABS (acrylonitrile-butadiene-styrene). Suitable reversible radical trapping agents can include cyclic nitroxides such as unsubstituted or substituted TEMPO compounds.

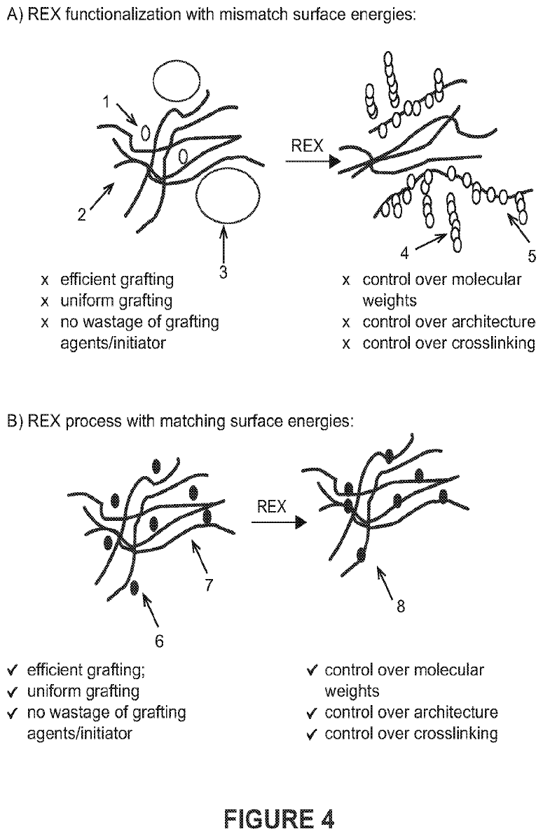

FIG. 4 illustrates that REX functionalization of a polymer using a grafting agent having a surface energy which is well-matched with that of the polymer can advantageously improve grafting homogeneity. Scheme A) shows REX functionalization of a CCB polymer 1 using a grafting agent 2 with mismatched surface energy, resulting in phase separation of the grafting agent 3, homopolymerization of the grafting agent 4, and a heterogeneously grafted CCB polymer 5. Scheme B) shows REX functionalization of a CCB polymer 7 using a grafting agent 6 with well-matched surface energy, resulting in a uniformly grafted CCB polymer 8.

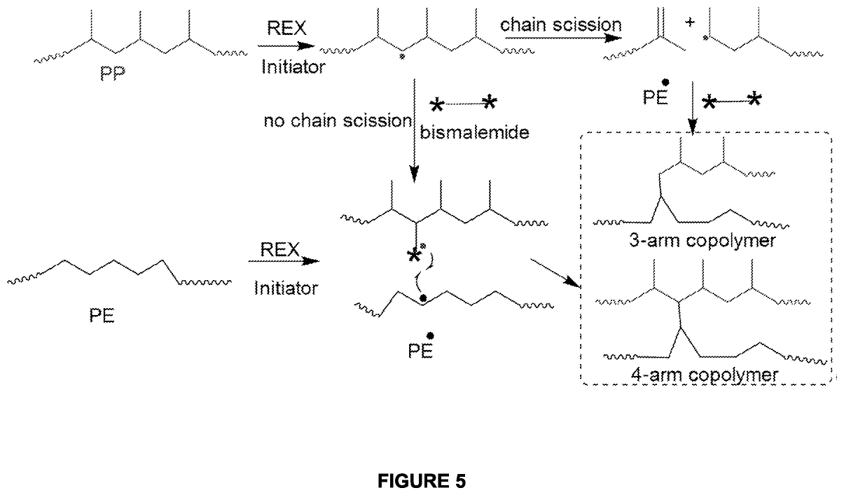

FIG. 5 illustrates that appropriately selecting free radical polymerization conditions for REX functionalization of PE, PP, or PE/PP blends can yield polymers with increasingly branched structures while minimizing undesirable chain scission. For instance, including a multifunctional grafting agent such as a bis(maleimide) as illustrated in FIG. 5 during REX processing of PE/PP can provide alternate reaction pathways for PE- or PP-based radicals which are formed in situ, leading to increased grafting of polymer chains to create, for instance, 3-or 4-arm copolymer structures while reducing formation of undesirable low-molecular weight scission byproducts.

In some cases, the grafting agent can further include a functional group to impart some additional or new chemical or physical property to the CCB polymer. In some cases, the reactively melt-processed mixture includes two or more different CCB polymers (e.g., from a recycled waste plastic source/stream) that are compatibilized via the grafting agent (e.g., with or without any additional functional group).

The disclosure provides efficient compatibilization of binary, ternary and higher polymer blends as well as functionalization of one or more polymers for applications in automotive, industrial, and construction applications. The reactive melt-processing (e.g., extrusion) method for functionalization and/or compatibilization of CCB polymers can be achieved with relatively low additive amounts, for example about 1-2 wt. % of the additives. In comparison the current reactive extrusion (REX) approaches utilize a much higher additive loading, for example about 10-15 wt. % additives. The disclosed method provides economic and performance benefits for composites made from virgin polymers, mechanically recycled polymer blends, and so on.

The compatibilization can be achieved by a variety of approaches. In a first approach, a mixture of plastics (virgin, post-industrial, post-consumer or combination) are added to the desired functionalization agents, and copolymers are formed in situ during melt-processing that act as compatibilizers. For example, in the case of carbon-carbon backbone polymer such as PP/PE, these polymers are loaded with functionalization agents and reactively melt-processed to make in situ copolymers of PE/PP. In a second approach, in situ copolymers are prepared by reactive melt-processing, and then the obtained mixture is used as a compatibilizer by blending it with other polymers in various ratios (e.g., as described in Example 3). In a third approach, functionalized CCB polymers are formed, and they can be mixed with PET or other condensation polymers such as nylon. In a fourth approach, a temperature gradient is utilized as a strategy to selectively functionalize CCB polymers in the presence of condensation polymers. Here, first, compatibilization of CCB polymers are functionalized at mild-high temperature (e.g., 220° C. using a grafting agent and radical initiator chemistry) at an early point in the temperature gradient. At this temperature, high melting-point (Tₘ) polymers such as PET will be solid particles and will have minimal exposure to free radicals. As melt-processing continues, the temperature is raised according to a desired gradient (e.g., lengthwise in a extruder), for example by raising the temperature to a sufficient value to melt the PET (e.g., 280° C.-285° C.) or other condensation polymer, whereupon the already functionalized CCB polymer from the upstream melt-processing can react with the PET or other condensation polymer. The choice of approach will depend on the plastics compositions and ease of processing and adaptability.

The disclosure provides new manufacturing possibilities using recycled plastics as feedstock. For example, polyolefins alone account for >60% of the total waste plastics, which can be upcycled by this approach. Single-use packaging which are difficult to recover, sort into individually polymer species are 69% made of polyolefins. These waste polyolefins end up in landfills or leak into the natural environments. Separation of these materials into individual species presents a daunting challenge. Physical blends of the mixed polyolefin wastes have poor mechanical and performance properties. The conversion of these materials to monomers via pyrolysis and thermal approaches is difficult because the C—C covalent bond is very strong.

### Carbon-Carbon Backbone Polymers

The CCB polymer can include any polymer with a —[C—C]ₙ— backbone and/or (only) —[C—C]— repeat units. For example, the CCB polymer can include —[CR₂—CR₂]— repeat units, where the R groups on the backbone independently can be hydrogen atoms, alkyl groups, aromatic groups, or other substituents. Examples of CCB polymers include common thermoplastics such as polyolefins (e.g., polyethylene (PE) and/or polypropylene (PP)) or polystyrenes (PS), for example as homopolymers or copolymers. The CCB polymer can include at least one olefin or styrene comonomer and at least one other comonomer including a vinyl reactive group (e.g., another olefin, another styrene, acrylonitrile or a different vinyl-containing monomer). The CCB polymer can comprise a mixture of two of more different polymers, such as, for instance, a mixture of two or more polyolefins.

When the CCP polymer is a polyolefin, the polyolefin is not particularly limited and can include polymers (e.g., homopolymers, copolymers) formed from olefinic or alkene monomers (e.g., alpha-olefin monomers) such as ethene, propene, 1-butene, 1-pentene, 1-hexene, etc., which are typically used in a variety of commodity thermoplastic materials. Common thermoplastic polyolefins can include polyethylenes (PE) such as high-density polyethylene (HDPE), low-density polyethylene (LDPE), linear low-density polyethylene (LLDPE), very-low-density polyethylene (VLDPE), ultra-low-density polyethylene (ULDPE), and medium-density polyethylene (MDPE), polypropylene (PP), polymethylpentene (PMP), polybutene-1 (PB-1), ethylene-octene copolymers, stereo-block PP, olefin block copolymers, propylene-butane copolymers, metallocene polymers, etc. Examples of common polyolefin elastomers include polyisobutylene (PIB), poly(alpha-olefins), ethylene propylene rubber (EPR), ethylene propylene diene monomer (M-class) rubber (EPDM rubber), etc. The polyolefin can be derived from a recycled and/or an otherwise post-consumer or post-industrial polyolefin feedstock. For example, the polyolefin can be a recycled polyolefin containing at least 90, 95, 98, or 99 wt. % and/or up to 99 or 100 wt. % of PE (e.g., one or more types), PP, or PE and PP. The polyolefin can be a pristine or newly formed feedstock that is transformed into a functionalized CCB polymer prior to its first industrial, consumer, engineering, etc. application. The polyolefin can include homopolymers or copolymers of the foregoing monomers, such as block, random, or graft copolymers, for example including pendant groups along the carbon-carbon backbone of the CCB polymer or functionalized CCB polymer (e.g., oligo- or polystyrene chains).

### Grafting Agents

The grafting agent can include unsaturated cyclic anhydrides, unsaturated cyclic imides, and/or ring-opened analogs, such as substituted or unsubstituted maleic anhydride, or a substituted or unsubstituted maleimide. The grafting agent can include one compound or a mixture of compounds suitable for grafting, such as a bis(maleimide) and maleic anhydride in combination. The disclosed functionalized CCB polymer is suitably formed using a grafting agent like maleimide or maleic anhydride as compared to a vinyl or alkenyl analog (e.g., CH₂═CH—R, where R includes linking moieties and/or crosslinking moieties) to improve grafting and avoid homopolymerization as an important benefit of the disclosed methods and compositions. Accordingly, grafting agents according to the disclosure preferentially react via free-radical addition to the CCB polymer backbone instead of via self-polymerization.

The grafting agent can have, for example, a 5-membered ring structure, a 6-membered ring structure, or a ring-opened structure (e.g., a difunctional analog). The 5- or 6-membered ring structure can be unsaturated. The ring structure can include carbon atoms and typically also includes one or more or heteroatoms, for example 1, 2, or 3 N or O atoms. For example, the ring structure can include a C═C bond that can participate in the free-radical grafting reaction between the grafting agent and the CCB backbone. Grafting agents of this type can include, for example, a maleic anhydride moiety or a maleimide moiety. Alternately, the ring structure can be saturated (e.g., including only C—C, C-heteroatom, and/or heteroatom-heteroatom single bonds in the ring) but can also include or exclude unsaturated C═C functional groups as part of the grafting agent. For example, a cyclic itaconic anhydride has a 5-membered saturated ring (with 4 carbon and 1 oxygen atoms), but it has a pendant C═C functional group that can participate in the free-radical grafting reaction.

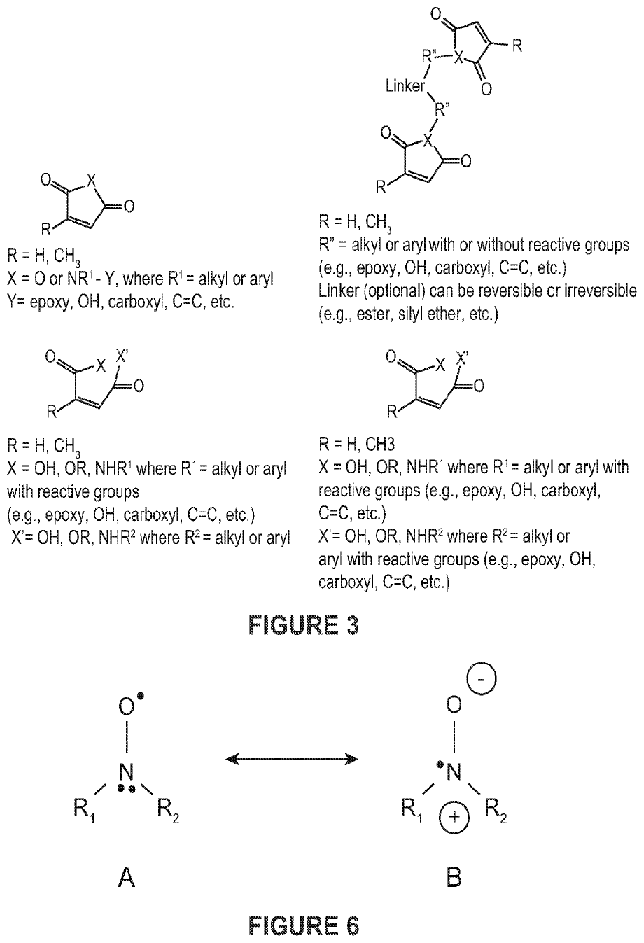

In addition to the cyclic 5- and 6-membered ring structure, the grafting agent can include a ring-opened analog of the ring structure. For example, common ring structures of the grafting agent can include oxygen atoms as part of an anhydride group or nitrogen atoms as part of an imide group. In such cases, the ring-opened analog can include hydroxy, alkoxy, and/or amino groups at each of the ring-opened carbonyl atoms to provide two corresponding carboxylic, ester, or amide groups in the ring-opened analog. Such ring-opened analogs can include two carbonyl carbon atoms joined by a linking group containing 2 or 3 atoms (e.g., carbon atoms with optionally 1 or 2 N or O heteroatoms) and an unsaturated C═C bond (e.g., along/within the linking group pendant thereon). Illustrative ring and ring-opened analog structures are shown in FIG. 3, where the various R substituents can independently include alkyl and/or aryl groups with, for instance, 1-12 or 2-6 carbon atoms. The top left structure can be maleic anhydride or a derivative thereof (i.e., when X is O), or maleimide or a derivative thereof (i.e., when X is NRY). The bottom left structure illustrates the ring-opened analog of the top left structure, with X and X′ representing the two carboxylic, ester, or amide groups in the ring-opened analog corresponding to the original anhydride or imide group, for example where X can further include or be substituted with a reactive group such as an epoxy, hydroxy, unsaturated, or carboxyl group. The bottom right structure similarly illustrates a ring-opened analog structure, but with X and X′ possibly including a reactive group. The top right structure can be a difunctional grafting agent with two maleimide rings joined by a linking group such as R″-[linker]-R″ (e.g., alkyl linkers R″ such as the R groups above and an irreversible or reversible linker such as an ester or silyl ether) or a alkyl linking group between the two X groups (e.g., such as the R groups above). Although illustrated with a single possible R group ring substituent, either or both of the ring (unsaturated) carbon atoms can include an alkyl or aryl group substituent in place of hydrogen in the various illustrate ring and corresponding ring-opened structures.

The grafting agent can contain an unsaturated cyclic anhydride moiety. Suitable unsaturated cyclic anhydrides include substituted and unsubstituted anhydrides of dicarboxylic acids containing a —C(═O)OC(═O)— group. Examples of suitable unsaturated cyclic anhydrides include maleic anhydride, itaconic anhydride, cis-glutaconic anhydride, citraconic anhydride, etc. In general, an unsaturated cyclic anhydride can be represented by R¹C(═O)OC(═O), where R¹ includes at least two atoms (e.g., carbon atoms) linking the two carbonyl carbon atoms in a cyclic structure and at least one (or only one) unsaturated C═C group as part of the cyclic structure, whether as part of the ring or pendant on the ring. For example, R¹ can have 2, 3, 4, 5, or 6 carbon atoms and optionally one or more N or O heteroatoms, for example 1, 2, or 3 N or O heteroatoms, which carbon and/or heteroatoms can be unsubstituted (with H) or substituted (with other than H). Suitably, 2, 3, 4, or 5 of the carbon and/or heteroatoms in R¹ can be those linking the two carbonyl carbon atoms in the cyclic structure. In some embodiments, R¹ can include a larger number of carbon atoms, for example up to 8, 10, 12, 15, or 20 carbon atoms, to adjust the surface energy of the cyclic anhydride for better surface energy-matching with the CCB polymer. As discussed above, the unsaturated C═C functional group that can participate in the free-radical grafting reaction with the CCB polymer backbone can be part of the cyclic ring structure (e.g., as in maleic anhydride) or pendant from the cyclic ring structure (e.g., as in itaconic anhydride). The unsaturated cyclic anhydrides are particularly useful because the unsaturated cyclic structure resists undesirable homopolymerization, instead favoring the desired free-radical addition reaction with the polyolefin backbone. The unsaturated cyclic anhydrides are also useful because hydrolysis and ring-opening of the anhydride by reaction with a polyol, polyepoxide, etc. can create both an ester bond with a pendant functional group or crosslinking group as well as a free carboxylic acid group. As discussed above, the cyclic grafting agent can include ring-opened analogs of its ring counterparts, such as an unsaturated diacid, diester, or diamide corresponding to the foregoing unsaturated cyclic anhydrides. For example, maleic acid as a ring-opened diacid analog to maleic anhydride could be used as a grafting agent that can graft to the CCB polymer backbone, react to form an ester bond as part of a pendant functional group or crosslinking group, and retain a free pendant acid group.

The grafting agent can contain an unsaturated cyclic imide moiety. Suitable unsaturated cyclic imides can include substituted and unsubstituted imides containing a —C(═O)NR²C(═O)— group. Examples of suitable unsaturated cyclic imides include maleimide and other imide analogs corresponding to an unsaturated cyclic anhydride (e.g., as described above) converted to an imide by reaction with a suitable amine (e.g., NH₂R²), etc. A general unsaturated cyclic anhydride can be represented by R¹C(═O)NR²C(═O), where R¹ includes at least two atoms (e.g., carbon atoms) linking the two carbonyl carbon atoms in a cyclic structure and at least one (or only one) unsaturated C═C group as part of the cyclic structure. R² can be a substituted or unsubstituted hydrocarbon or alkyl group, for example having 1 to 20 carbon atoms (e.g., at least 1, 2, 3, 4, 6, or 8 and/or up to 4, 6, 8, 10, 12, 15, or 20 carbon atoms), which can be unsubstituted or substituted with a hydroxy group, an epoxide group, etc. R¹ can have the same options as above for the unsaturated cyclic anhydrides. As discussed above, the unsaturated C═C functional group that can participate in the free-radical grafting reaction with the polyolefin backbone can be part of the cyclic ring structure (e.g., as in maleimide). The unsaturated cyclic imides are particularly useful because the unsaturated cyclic structure resists undesirable homopolymerization, instead favoring the desired free-radical addition reaction with the polyolefin backbone. The unsaturated cyclic imides are also useful because the pendant R² group in the imide can include a functional group or a linking group, for example a hydrocarbon linker with another cyclic imide group. More generally, imides such as maleimide can bear functional groups such as OH (e.g., as in N-(2-hydroxyethyl)maleimide), COOH (e.g., as in 6-maleimidohexanoic acid), epoxy (e.g., as in N-(2-epoxyethyl)maleimide), and unsaturated carbon-carbon group (C═C), etc., for example in the R² group. As discussed above, the grafting agent can include ring-opened analogs of its ring counterparts, such as an unsaturated diacid, diester, or diamide corresponding to the foregoing unsaturated cyclic imides.

The grafting agent can also contain a pendant functional group selected from the group consisting of a silyl ether, a further unsaturated carbon-carbon group (C═C), a hydroxy group, a carboxylate group, an epoxide (or oxirane) group, an amino group, an ester group, and combinations thereof. The functional groups appended to the CCB polymer via the grafting agent are not particularly limited, but they can be selected to impart some additional or new chemical or physical property to the CCB polymer. In some embodiments, the functional group does not promote crosslinking of the CCB polymer, for example when the grafting agent is monofunctional with respect to its reactive unsaturated group and the pendant functional group is not reactive with the CCB polymer or other components of the reactively melt-processed mixture. The pendant functional group can be bound or otherwise appended to the grafting agent at any suitable position, for example at a ring nitrogen atom in a malemide or other cyclic grafting agent, at a ring unsaturated carbon in a malemide, maleic anhydride, or other cyclic grafting agent, at a carbonyl-containing group (e.g., an ester or amide group) in a ring-opened maleic anhydride, etc.

The grafting agent can also contain at least two (e.g., only two) unsaturated groups. The grafting agent can include two or more unsaturated groups to provide some low degree of branching and/or crosslinking in the original CCB polymer, which can be useful to compatibilize a mixture of different CCB polymers (e.g., a blend of different polyolefins in a recycled plastic waste stream) and/or help to maintain or control the molecular weight of the CCB polymer(s). Suitably the grafting agent includes only two unsaturated groups in such embodiments to limit potentially excessive crosslinking. Grafting agents with multiple unsaturated groups can be formed from two or more of the above 5-membered ring structures, a 6-membered ring structures, or corresponding ring-opened analogs joined together by a suitable linking group. For example, two maleimide rings can be joined by a suitable linking group between their respective ring nitrogen atoms (e.g., formed via diamine reaction with maleic anhydride) to form a corresponding difunctional maleimide. Similarly, two ring-opened maleic anhydride rings can be joined by a linking group between respective ester groups (e.g., formed by ring-opening diol reaction with maleic anhydride) to form a corresponding difunctional ring-opened maleic anhydride.

In embodiments, the surface energy of the grafting agent is suitably selected to be comparable in magnitude to that of the CCB polymer. For example, the surface energy ratio can be at least 0.02, 0.05, 0.1, 0.2, 0.3, 0.5, 0.7, 0.9, or 1.2 and/or up to 0.5, 0.8, 1.0, 1.1, 1.2, 1.4, 1.6, 1.8, or 2.0. Selection of the grafting agent surface energy in this way can improve the melt miscibility of the CCB polymer and the grafting agent. This can further improve graft uniformity and/homogeneity, providing a more consistent distribution or addition of the grafting agent to the CCB polymer backbone. This also can increase the likelihood that the CCB polymer and the grafting agent react with each other, which in turn reduces the relative amount of grafting agent-grafting agent reactions (e.g., undesirable homopolymerization or block formation) and reduces the relative amount of CCB polymer-CCB polymer reactions (e.g., undesirable crosslinking or chain extension/MW increase). When the relative surface energies are substantially different, the grafting agent to the CCB polymer tend to form a relatively more inhomogeneous or segregated melt structure, which can lead to undesirable homopolymerization, crosslinking, etc.

In some embodiments, an absolute surface energy (or surface energy difference) can be selected in addition to or instead of the surface energy ratio to reflect selection of the grafting agent to improve melt miscibility. For example, the absolute surface energy of the grafting agent and/or the (original) CCB polymer(s) can be in a range of 10-60 or 20-50 dyne/cm, for example at least 10, 15, 20, 25, 30, 35, or 40 dyne/cm and/or up to 30, 35, 40, 45, 50, 55, or 60 dyne/cm. By way of example, typical polyolefins such as PE and PP generally have an absolute surface energy of about 30 dyne/cm (e.g., 25-35 dyne/cm). Maleimide grafting agents can have an absolute surface energy of about 20-35 dyne/cm, for example when including one or more (alkyl) side chains to adjust the surface energy. Maleic anhydride grafting agents can have an absolute surface energy of about 40 dyne/cm or higher. In some embodiments, a surface energy difference between the grafting agent and/or the (original) CCB polymer(s) can be within 2, 5, 10, or 15 dyne/cm (e.g., the magnitude of the difference between the absolute surface energy of the grafting agent and the CCB polymer where either could be higher than the other, but within 2, 5, 10, or 15 dyne/cm from each other).

The surface energy can be determined by any suitable method known in the art. The most common way to measure surface energy is through contact angle experiments. In this method, the contact angle of a surface (e.g., formed from the CCB polymer, grafting agent, or functionalized CCB polymer) is measured with several liquids, usually water and diiodomethane. Based on the contact angle results and knowing the surface tension of the liquids, the surface energy can be calculated according to known methods.

### Initiators

The initiator is suitably a peroxide free-radical initiator. The initiator is not particularly limited, however, and can include free-radical initiators known in the art, for example organic peroxides, inorganic peroxides, and azo compounds. Example peroxide free-radical initiators include di(tert-butylperoxy)-3,3,5-trimethylcyclohexane, dicumyl peroxide, 2,5-bis(tert-butylperoxy)-2,5-dimethylhexane (e.g., LUPEROX 101), 1,1-bis(tert-butylperoxy)-3,3,5-trimethylcyclohexane 92% (LUPEROX 231), tert-butyl hydroperoxide, tert-butyl peracetate, benzoyl peroxide, di-tert-butyl peroxide, di-isobutyl peroxide, etc. While one can choose from the many known free-radical initiator sources, more preferable are those initiators that have a half-life of about 1 to 20 minutes at elevated temperatures, for example at reactive melt-processing temperatures such as above 100° C. The initiator is suitably added to the reactive melt-processing mixture in an amount of 0.01-10 wt. % or 0.1-1 wt. % (e.g., based on the amount of CCB polymer). For example, the initiator can be present in amount of at least 0.01, 0.02, 0.05, 0.1, 0.2, or 0.4 wt. % and/or up to 0.3, 0.4, 0.6, 0.8, 1, 2, 4, 6, or 10 wt. %. The initiator can remain in residual corresponding amounts in the functionalized CCB polymer product.

In embodiments, the initiator half-life can be selected to be comparable in magnitude to the residence time for the reactive melt-processing process, for example whether reactive extrusion or otherwise. In general, the half-life is the time required to reduce the original initiator content of a solution by 50%, at a given temperature. For example, for a peroxide initiator, the half-life can represent time required for half of the existing ROOR initiator molecules to decompose to corresponding RO· radicals that can initiate free-radical addition at a given temperature. The residence time can be determined as generally known in the art for reactive systems, for example being expressed as a ratio of the internal volume of the reactive melt processing apparatus (e.g., extruder) relative to the volumetric rate or throughput of polymer for the apparatus). Selection of the initiator half-life in this way can provide a relatively slower, more controlled release of initiator radical in a way that reduces undesirable molecular weight losses (e.g., via chain scission) and/or crosslinking while still promoting the desired free-radical-initiated reaction between the CCB polymer and the cyclic grafting agent. In various embodiments, the half-life ratio can be at least 0.2, 0.4, 0.6, 0.8, 0.9, 1.0, 1.2, 1.5, or 2 and/or up to 0.5, 0.7, 1, 1.1, 1.2, 1.4, 1.6, 1.8, 2.0, 2.5, 3.0, 4.0, or 5.0. Additionally or alternatively (i.e., independent of whether condition (B) applies), the initiator can be selected to have a half-life of 1-20 minutes or 3-10 minutes at the reactive melt-processing temperature (e.g., maximum temperature for a variable-temperature process), for example at least 1, 2, 3, 4, 5, 7, or 9 minutes and/or up to 2, 4, 6, 8, 10, 12, 15, or 20 minutes. Additionally or alternatively (i.e., independent of whether condition (B) applies), the reactive melt-processing operating conditions can be selected to have a residence time of 1-20 minutes or 3-10 minutes, for example at least 1, 2, 3, 4, 5, 7, or 9 minutes and/or up to 2, 4, 6, 8, 10, 12, 15, or 20 minutes.

### Reactive Extrusion/Reaction Melt Processing

The functionalized CCB polymer can be formed by any suitable method for reactive melt-processing of its mixture including the CCB polymer, the grafting agent, the initiator, and any other optional reversible radical trapping agents, additives, fillers, processing aids, etc. Suitably, reactive melt-processing of the mixture is performed by reactively extruding the mixture. Any apparatus typically used for melt-processing of the PO polymers may be used, for example twin- and single-screw extrusion apparatus operated at a sufficiently high temperature to melt the base polymer material, for example including the CCB polymer(s) being functionalized as well as any non-CCB polymer(s) being co-melt processed.

The reactively melt-processed mixture according to the disclosure can contain the CCB polymer in an amount in a range from 40 wt. % to 99 wt. %, 80 wt. % to 99 wt. %, or 90 wt. % to 98 wt. % relative to the total weight of the mixture. Suitably, the CCB polymer accounts for at least 40, 60, 80, 85, 90, 92, or 95 wt. % and/or up to 50, 70, 80, 90, 92, 94, 96, 98, or 99 wt. % of the reactively melt-processed mixture. The foregoing ranges can apply to independently to a single CCB polymer in the mixture, or the combined amount of all CCB polymers and other polymers (when present). Similarly, in various embodiments, the combined amount of non-polymer components (e.g., grafting agent, initiator, reversible radical trapping agent (when present), and any included additives or fillers) accounts for at least 1, 2, 3, 5, or 7 wt. % and/or up to 4, 6, 8, 10, 12, 15, or 20 wt. % of the reactively melt-processed mixture.

The functionalized CCB polymer produced by reactive melt processing may contain at least 50% or at least 90% of the original amount of grafting agent directly bound to the CCB polymer backbone. In particular, at least 20, 30, 40, 50, 60, 80, 90, 95 or 98% and/or up to 50, 70, 90, 95, 99 or 100% of the original amount of grafting agent can be directly bound to the CCB polymer backbone. Alternatively or additionally, not more than 1, 2, 5, 10, 20, 30, 40, or 50% of the grafting agent molecules are bound to another grafting agent molecule. Grafting agent-grafting agent bonding can result in formation of a separate homopolymer or formation of a grafting agent block appended to the CCB polymer backbone, both of which are generally undesirable. More generally, the functionalized CCB polymer can be characterized as having an improved homogeneity or uniformity of the grafting agent bound to the CCB polymer instead of remaining unreacted and/or being homopolymerized. Solvent extraction of the reaction product can be used to test if there is any grafting agent homopolymer or any CCB polymer with highly non-uniform grafting, for example via FTIR and NMR analysis of the grafted copolymer after solvent extraction. Crystallinity analysis of the reaction product also can be used to characterize grafting uniformity: a uniformly grafted reaction product will exhibit a new (single) melting temperature (Tₘ) distinct from that of the original CCB polymer, while a non-uniformly grafted reaction product may exhibit multiple distinct melting temperatures corresponding, for example, to the original CCB polymer and to non-uniformly grafted functionalized CCB polymer.

The reactively melt-processed mixture can contain at least two (e.g., only two) different CCB polymers. For example, the reactively melt-processed mixture can contain polyethylene as a first CCB polymer and polypropylene as a second CCB polymer. In some cases, the reactively melt-processed mixture includes two or more different CCB polymers (e.g., from a recycled waste plastic source/stream) that are compatibilized via the grafting agent (e.g., with or without any additional functional group). A difunctional grafting agent (e.g., bismaleimide) can promote compatibilization by joining fragments or other radical-containing analogs of the different CCB polymers formed during reactive melt-processing via the difunctional grafting agent. A monofunctional grafting agent (e.g., maleic anhydride, maleic acid) can similarly promote compatibilization when a coupling agent is added to the reactively melt-processed mixture. Di- or otherwise poly-functional coupling agents such diols, diamines, diepoxies, etc. can react to form ester or amide links between ring-opened anhydride monofunctional grafting agents (e.g., forming a difunctional grafting agent in situ during reactive melt-processing). Suitable coupling agents can include 1 to 20 carbon atoms (e.g., at least 1, 2, 3, 5, 6, 8, or 10 and/or up to 2, 4, 6, 9, 12, 15 or 20 carbon atoms in alkyl and/or aromatic groups) with 2, 3, 4, or more hydroxy, amino, or epoxy groups. For example, an initial blend of two polymers P₁ (e.g., PE) and P₂ (e.g., PP) melt-processed according to the disclosure can form a P₁/P₂ copolymer formed from a portion of the original P₁ and P₂ polymers joined via the grafting agent, while a portion of the original P₁ and P₂ polymers remain in their original form (or at least not copolymerized with the other polymer). The P₁/P₂ copolymer, having structures in common with the original P₁ and P₂ polymers serves to compatibilize the blended mixture.

The reactively melt-processed mixture can contain a further polymer. The further polymer can be another CCB polymer, such that the mixture contains two or more different CCB polymers. The further polymer can be other than a CCB polymer, such that the mixture contains at least one CCB polymer and at least one non-CCB polymer. Examples of suitable non-CCB polymers include various condensation polymers such as polyesters (e.g., polyethylene terephthalate (PET), poly(lactic acid) (PLA), etc.), polyamides (e.g., various nylon grades), and other thermoplastics. Thus, as similarly described above, the reactively melt-processed mixture can includes two or more different polymers (e.g., from a recycled waste plastic source/stream) that are compatibilized via the grafting agent (e.g., with or without any additional functional group). A difunctional grafting agent or monofunctional grafting agent in combination with a coupling agent can be used as described above. Examples of multi-component/multi-polymer systems that can be compatibilized include (1) two or more of HDPE, LDPE, LLDPE, and PP (with or without other impurities); (2) two or more of HDPE, LDPE, LLDPE, PP, and PS (with or without other impurities); (3) two or more of LDPE, LLDPE, and PP (with or without other impurities); (4) two or more of LDPE, LLDPE, PP, and PS (with or without other impurities); and (5) one or more of HDPE, LDPE, LLDPE, PP, and PS with one or more condensation polymers (e.g., PET, PLA, nylon). Any of the foregoing multi-component/multi-polymer systems can further include one or more fillers such as silica, carbon fibers, glass fibers, etc. Any of the foregoing multi-component/multi-polymer systems similarly can further include one or more impurities or contaminants (e.g., present a polymer waste stream for recycling) such as silica (e.g., present as an impurity as contrasted with an intentional functional additive), cellulosic material (e.g., paper), etc., for example in amounts of at least 0.1, 0.2, 0.5, or 1 wt. % and/or up to 1 2, 3, 5, 7, or 10 wt. % relative to the melt-processed mixture or total polymer content. An advantage of the disclosed methods and functionalized CCB polymers is that the presence of contaminants or impurities (e.g., in relative low amounts) do not need to be removed or separated before reprocessing/recycling a mixed polymer waste stream, because their presence in the reprocessed/recycled material does not substantially adversely affect the final material properties.

The functionalized CCB polymers can be used for the compatibilization of a binary mixed plastics system (virgin, post-industrial, post-consumer or combination) comprised of (i) a CCB polymer and another CCB polymer as well as (ii) a CCB polymer and a condensation polymer such as PP/PE, PP/PS, PE/PS, PE/PET, PET/PP, PE/PLA, etc. The functionalized CCB polymers can also be used for the compatibilization of ternary mixed plastics system (virgin, post-industrial, post-consumer or a combination) comprised of (i) all CCB polymers, or (ii) a combination of at least one CCB polymer and at least one condensation polymer such as PP/PE/PS, PP/PE/PET, etc. The functionalized CCB polymers can also be used for the compatibilization of quaternary and even higher blends mixed plastics system (virgin, post-industrial, postconsumer or combination) comprised of (i) all CCB polymers, or (ii) a combination of at least one CCB polymer and at least one condensation polymer such as PP/PE/PS/PET, PP/PE/PS/ABS, etc. The compatibilization can be combined with polymer processing methods such as drawing, fibers/fillers, and/or waste fibers (such as from old newspaper) to achieve desirable properties. In certain embodiments, the cyclic grafting agents can be used along with other vinyl/allyl compounds such as allyl trimethoxy silane, allyl triethoxy silane, other alkoxy silanes, etc, for the functionalization of CCB polymers. The compatibilization can be used for LLDPE/LDPE and PP mixed plastics (virgin, post-industrial, postconsumer). Complex multiple packages made of all polyolefins, or polyolefins and condensation polymers, can be compatibilized by this approach.

The melt-processed mixture can contain the grafting agent in a range from 0.5 wt. % to 50 wt. % relative to the CCB polymer. The amount of the grafting agent is not particularly limited and can be selected based on the desired level of functionalization in the final functionalized CCB polymer. For example, the melt-processed mixture can include one or more grafting agents in an amount of at least 0.5, 1, 2, 5, 10, 15, 20, or 30 wt. % and/or up to 2, 3, 5, 7, 10, 12, 15, 25, 35, or 50 wt. % relative to the CCB polymer.

In embodiments, a molecular weight ratio of the functionalized CCB polymer relative to that of the CCB polymer can be in a range from 0.2 to 3 or 0.5 to 1.5. The molecular weight ratio represents a final/initial ratio of molecular weight values to reflect that excessive chain scission and/or crosslinking does not occur such that the final molecular weight of the functionalized CCB polymer is desirably close to the initial molecular weight of the (original) CCB polymer. The molecular weight values used to determine the molecular weight ratio can represent weight- or number-average molecular weight values. In various embodiments, the molecular weight ratio can be at least 0.2, 0.3, 0.5, 0.7, 0.8, 0.9, 1, or 1.1 and/or up to 0.6, 0.8, 1, 1.1, 1.2, 1.4, 1.7, 2, 2.5, or 3.

### Optional Components

In embodiments, the reversible radical trapping agent is present in the reactively melt-processed mixture. The radical trapping agent can reversibly bond/de-bond with polymer chain radicals (e.g., represented by —CH₂—CH(·)—CH₂—) generated during reactive melt-processing via the initiators. Such reversible bonding/de-bonding can limit the available polymer chain radical sites that might otherwise result in undesirable crosslinking and/or excessive molecular weight increase (e.g., as can happen with PE in other processes), or undesirable chain scission and/or excessive molecular weight decrease (e.g., as can happen with PP in other processes). The radical trapping agent is included in a suitable amount so that at least some available polymer chain radical sites remain for reaction between the CCB polymer and the cyclic grafting agent.

When a reversible radical trapping agent is present, the reversible radical trapping agent can suitably be a cyclic nitroxide. In addition to cyclic nitroxides, other reversible radical-bonding compounds can be used, for example sulfur compounds such as dithiocarbamyl compounds. The radical trapping agent can be a cyclic nitroxide such as substituted or unsubstituted (2,2,6,6-tetramethylpiperidin-1-yl)oxidanyl (“TEMPO”). The cyclic TEMPO nitroxide has a 6-membered saturated ring (with 5 carbon and 1 nitrogen atoms) that can be free from pendant C═C functional groups, but its N—O nitroxide group as part of the TEMPO ring can reversibly react with the CCB polymer backbone. The radical trapping agent, for example a cyclic nitroxide or otherwise, can be used to increase grafting efficiency of the grafting agents (e.g., unsaturated cyclic anhydrides or imides). In addition to the TEMPO group, the cyclic nitroxide more generally can include any nitroxide radical that does not itself initiate any free radical polymerization of the monomer. The nitroxide can be TEMPO (i.e., a 6-membered ring). Alternately, the nitroxide can be in a structure without a ring, but still containing an N—O group (i.e. radical on oxygen atom) In the illustrative cyclic nitroxide structure shown in FIG. 5, the R groups can independently have 2-12 carbon atoms as separate groups or collectively have 2-12 carbon atoms in a cyclic aliphatic structure (e.g., as in TEMPO), which can be further substituted with a group bearing a linking functional group (e.g., hydroxy, epoxy, carboxylic) and a crosslinking moiety such as the R² group described above for the unsaturated cyclic imide.

When a reversible radical trapping agent is present, the melt-processed mixture can contain the reversible radical trapping agent in a range from 0.01 wt. % to 10 wt. % or 0.5 wt. % to 2 wt. % relative to the CCB polymer. For example, the melt-processed mixture can include one or more reversible radical trapping agents in an amount of at least 0.01, 0.1, 0.2, 0.5, 1, 1.5, or 2 wt. % and/or up to 0.5, 1, 2, 3, 5, 7, or 10 wt. % relative to the CCB polymer.

The melt-processed mixture can further contain one or more additives such as rheology modifiers, co-agents, fillers, etc. Examples of rheology modifiers include waxes, plant oils, low-MW (molecular weight) polyolefins, and low-MW linear polyesters and polyolefins. Suitable MW ranges for such rheology modifiers include 200-5000 g/mol, and the rheology modifiers remain in admixture with the final CCB polymer (i.e., they are generally non-reactive). Example co-agents include donor molecules such as N,N′-ethylenebis(stearamide), dimethyl formamide (DMF), dimethyl acetamide, to suppress crosslinking in PE and suppress chain scission in PP. Butylated hydroxytoluene (BHT) or dithiocarbamyl can be used as a co-agent to increase grafting density. Suitable fillers includes silica, fibers such as carbon fibers, glass fibers, etc. The additives can be included individually or collectively in an amount of 0.01-20 wt. %, 0.1-10 wt. %, or 1-5 wt. %, relative to the weight of the CCB polymer or functionalized CCB polymer.

### EXAMPLES

The following examples illustrate the disclosed compositions and methods, but are not intended to limit the scope of any claims thereto.

In the following examples, reactive extrusion was performed using a DSM Xplore 15 cc Micro Extruder equipped with a co-rotating conical twin screw. In general, CCB polymers such as HDPE (high density polyethylene), LDPE (low-density polyethylene), LLDPE (linear low-density polyethylene), and/or PP (polypropylene) were fed to the extruder and melted at about 230° C. Once the polymer had melted, any compatibilizers or other additives were typically added in two increments over about 20 seconds. The resulting mixture was compounded for about 3 minutes. Dumbbell-shaped samples were prepared by injecting the molten mixture in a mold using a 3.5 cc injection molder at about 100° C. unless stated otherwise.

Mechanical testing of extruded polymer samples was performed using a computer-controlled Universal testing machine (Instron 5565) according to ASTM D-638. Samples were tested at a crosshead speed of 10 mm/min. Impact testing was performed in notched impact testing mode using a RAY-RAN Izod impact tester equipped with a hammer (velocity=3.46 m/s, weight=0.905 kg) controlled by an advanced microprocessor.

### Example 1: Functionalized/Compatibilized HDPE/PP Blends

In Example 1, HPDE/PP CCB blends were functionalized in situ to form functionalized CCB polymers, including a HPDE/PP compatibilizing copolymer present in the product that compatibilizes the blend (e.g., including or more of functionalized HDPE, functionalized PP, non-functionalized HOPE, and non-functionalized PP). Table 1 lists the components of several reactive additive compositions which are designed to enable compatibilization of polymer blends. Amounts in Table 1 are provided as relative amounts on a weight basis, normalized to one hundred parts by weight of the grafting agent in the additive composition. The R8 additive composition contains maleic anhydride as the grafting agent, while the R10 additive compositions contain N,N′-(1,3-phenylene)dimaleimide as the grafting agent.

TABLE 1

| | | | R10c- | R10c- | |
|---|---|---|---|---|---|
| Component | R8 | R10b | Stearamide | TEMPO | R10d |
| Maleic anhydride | 100 | | | | |
| N,N′-(1,3- | | 100 | 100 | 100 | 100 |
| phenylene)dimaleimide | | | | | |
| Dicumyl peroxide | 8.9 | 8.9 | 8.9 | 8.9 | 4.5 |
| 1,10-decanediol | 142.9 | | | | |
| Zinc acetate | 23.8 | | | | |
| N,N′- | 23.8 | 23.8 | 44.2 | | |
| ethylenebis(stearamide) | | | | | |
| 4-hydroxy-TEMPO | | | | 29.0 | |

Extruded polymer samples were prepared according to the compositions listed in Table 2. In particular, 70:30 (w/w) blends of HPDE:PP were extruded with various levels of the reactive additive compositions described in Table 1. Extruded samples of neat HOPE, neat PP, and 70:30 HPDE:PP without compatibilizer were also prepared. The mixture was fed in and compounded in an extruder at a temperature of 230° C. for 3 minutes with a continuous purging of nitrogen purge gas. Specimens were prepared in dumbbell shape by injecting molten mixture into a mold at a temperature of 80° C. Table 3 lists mechanical properties of the neat and compatibilized extruded polymer samples described in Table 2.

TABLE 2

| | | Total | | | | | |
|---|---|---|---|---|---|---|---|
| | | additive | | | R10c- | R10c- | |
| | | level | R10b | R8 | Stearamide | TEMPO | R10d |
| Sample | Resin | (wt %) | (wt %) | (wt %) | (wt %) | (wt %) | (wt %) |
| HDPE | HDPE | 0 | | | | | |
| PP | PP | 0 | | | | | |
| HDPE/PP-(70:30) | HDPE/PP (70:30) | 0 | | | | | |
| R10b-1% | HDPE/PP (70:30) | 1 | 1 | | | | |
| R10b-2% | HDPE/PP (70:30) | 2 | 2 | | | | |
| R8-1% | HDPE/PP (70:30) | 1 | | 1 | | | |
| R8-2% | HDPE/PP (70:30) | 2 | | 2 | | | |
| (R10b/R8)-2% (1:1) | HDPE/PP (70:30) | 2 | 1 | 1 | | | |
| (R10b/R8)-3% (2:1) | HDPE/PP (70:30) | 3 | 2 | 1 | | | |
| (R10b/R8)-3% (1:2) | HDPE/PP (70:30) | 3 | 1 | 2 | | | |
| (R10b/R8)-4% (2:2) | HDPE/PP (70:30) | 4 | 2 | 2 | | | |
| R10c-Stearamide | HDPE/PP (70:30) | ~2.81 | | | ~2.81 | | |
| R10c-TEMPO | HDPE/PP (70:30) | ~2.53 | | | | ~2.53 | |
| R10d | HDPE/PP (70:30) | 2 | | | | | 2 |

TABLE 3

| | Tensile | Tensile | | Elongation |
|---|---|---|---|---|
| | Stress at | Strength at | Modulus | at Break |
| Sample | Yield (MPa) | Break (MPa) | (MPa) | (%) |
| HDPE | 32.9 | 19.9 | 333.3 | 211.3 |
| PP | 46.5 | 54.2 | 906.6 | 918.6 |
| HDPE/PP-(70:30) | 34.9 | 13.9 | 508.4 | 245.5 |
| R10b-1% | 35.5 | 14.3 | 456.1 | 97.4 |
| R10b-2% | 33.7 | 26.1 | 422.1 | 43.5 |
| R8-1% | 34.6 | 22.5 | 523.7 | 710.3 |
| R8-2% | 34.0 | 23.7 | 476.9 | 712.1 |
| (R10b/R8)-2% (1:1) | 34.7 | 15.5 | 474.3 | 74.5 |
| (R10b/R8)-3% (2:1) | 34.0 | 16.4 | 452.0 | 35.4 |
| (R10b/R8)-3% (1:2) | 34.6 | 13.9 | 435.5 | 69.6 |
| (R10b/R8)-4% (2:2) | 33.7 | 13.5 | 380.7 | 74.6 |
| R10c-Stearamide | 32.8 | 23.7 | 415.5 | 41.6 |
| R10c-TEMPO | 33.9 | 25.3 | 443.6 | 859.4 |
| R10d | 36.3 | 24.7 | 450.4 | 38.3 |

As seen in Table 3, there was only slight variation in tensile strength at yield among the compatibilized blend samples. The tensile strengths at yield of the compatibilized blend samples, ranging from 32.8-36.3 MPa, are nearly identical that of the uncompatibilized HDPE:PP blend sample (34.9 MPa) and only slightly higher than that of neat HOPE sample (32.9 MPa).

Table 3 also shows that many of the compatibilized blend samples exhibited higher tensile strength at break compared to the neat blend.

Several samples exhibited very high elongation at break. In particular, R8-1% and R8-2%, which were prepared using the reactive additive package containing maleic anhydride, 1,10-decanediol, and zinc acetate, exhibited roughly threefold higher elongation at break compared to the neat HDPE:PP blend. Also, the sample prepared using a radical trapping agent (R10c-TEMPO) also exhibited ˜3.5× higher elongation at break compared to the neat HDPE:PP blend. Notably, among the samples compatibilized with N,N′-(1,3-phenylene)dimaleimide as the only grafting agent (i.e., the R10 samples), only the sample that contained TEMPO exhibited this very high elongation; all other R10 samples exhibited lower elongation at break compared to the neat blend.

Additionally, all R10/R8 samples, which contained both maleic anhydride and N,N′-(1,3-phenylene)dimaleimide grafting agents, exhibited much lower elongation at break compared to the neat blend and substantially lower elongation at break compared to the R8 samples, which contained maleic anhydride as the only grafting agent.

### Example 2: Functionalized/Compatibilized Polyolefin Blends and Effects of Contaminants

In view of the unexpected increases in tensile stress at break and elongation at break exhibited by HDPE:PP compatibilized blend samples containing the R8 or R10c-TEMPO additive compositions, these additive compositions were evaluated further. R8 and R10c-TEMPO were used to compatibilize a blend of polyolefins that was intended to represent a typical composition of waste plastics. The blend of polyolefins, hereafter referred to as “PO Mix,” comprised 26% HDPE, 18% LDPE, 18% LLDPE and 38% PP (w/w). The PO Mix was extruded without any reactive additives (“Neat PO Mix”) and with varying levels of the R8 and R10c-TEMPO reactive additive compositions, as noted in Tables 4 and 5. The mixture was fed in and compounded in an extruder at a temperature of 230° C. for 3 minutes with a continuous purging of nitrogen purge gas. Specimens were prepared in dumbbell shape by injecting molten mixture into a mold at a temperature of 80° C. Mechanical properties of the samples were evaluated. Similar to Example 1, the PO mix (i.e., a CCB blend) was functionalized in situ to form functionalized CCB polymers, including a compatibilizing copolymers between original PO mix components, which can compatibilize the blend (e.g., including or more of functionalized and non-functionalized PO mix component that are not in the form of copolymers).

TABLE 4

| | | R10c- | R10c- |
|---|---|---|---|
| Component | R8 | TEMPO (0.2 eq) | TEMPO (0.5 eq) |
| Maleic anhydride | 100 | | |
| N,N′-(1,3- | | 100 | 100 |
| phenylene)dimaleimide | | | |
| Dicumyl peroxide | 8.9 | 8.9 | 8.9 |
| 1,10-decanediol | 142.9 | | |
| Zinc acetate | 23.8 | | |
| N,N′- | 23.8 | | |
| ethylenebis(stearamide) | | | |
| 4-hydroxy-TEMPO | | 7.5 | 29.0 |

TABLE 5

| | Tensile Strength | Elongation at |
|---|---|---|
| Sample | at Break (MPa) | Break (%) |
| Neat PO Mix | 19.4 | 533.9 |
| R8-1% | 25.8 | 758.8 |
| R8-2% | 21.7 | 840.9 |
| R10c-TEMPO (0.2 eq) | 31.1 | 906.8 |
| R10c-TEMPO (0.5 eq) | 21.3 | 707.8 |

To evaluate how contamination could impact the effectiveness of polymer compatibilization by reactive additives of the disclosure, samples containing the PO Mix and R10c-TEMPO (i.e., the base PO mixture with R10c-TEMPO compatibilizer) were extruded in the presence of varying levels of paper or silica (wt. %) as model contaminants or impurities. As model impurities, 15 nm silica particles were used, while paper fiber was recycled from kraft paper and used them as additive. Sample descriptions and mechanical properties are shown in Table 6, and compositions for the various sample codes are shown in Table 7 (additive and filler/impurity amounts relative to total resin/polymer).

TABLE 6

| | Tensile Strength | Elongation at |
|---|---|---|
| Sample | at Break (MPa) | Break (%) |
| Neat PO mix | 19.4 | 533.9 |
| PO mix + 2% paper | 13.2 | 587.3 |
| R10c-TEMPO | 31.1 | 906.8 |
| R10c-TEMPO + 1% Paper | 21.2 | 815.3 |
| R10c-TEMPO + 2% Paper | 16.7 | 479.7 |
| R10c-TEMPO + 1% Silica | 30.2 | 959.0 |
| R10c-TEMPO + 2% Silica | 30.7 | 832.5 |
| R10c-TEMPO + 4% Silica | 28.1 | 331.3 |

TABLE 7

| | | Additive Loading (wt %) | | | | |
|---|---|---|---|---|---|---|
| | | | R10c- | R10c- | Filler Loading (wt %) | |
| | Resin's Composition | | TEMPO | TEMPO | Paper | |
| Sample Code | (HDPE/LDPE/LLDPE/PP) | R8 | (0.2 eq) | (0.5 eq) | Fibers | Silica |
| Neat PO Mix | 26:18:18:38 | | | | | |
| R8-1% | 26:18:18:38 | 1 | | | | |
| R8-2% | 26:18:18:38 | 2 | | | | |
| R10c-TEMPO (0.2 eq) | 26:18:18:38 | | 2.5 | | | |
| R10c-TEMPO (0.5 eq) | 26:18:18:38 | | | 2.5 | | |
| PO mix + 2% paper | 26:18:18:38 | | | | 2 | |
| R10c-TEMPO | 26:18:18:38 | | 2.5 | | | |
| R10c-TEMPO + 1% | 26:18:18:38 | | 2.5 | | 1 | |
| Paper | | | | | | |
| R10c-TEMPO + 2% | 26:18:18:38 | | 2.5 | | 2 | |
| Paper | | | | | | |
| R10c-TEMPO + 1% | 26:18:18:38 | | 2.5 | | | 1 |
| Silica | | | | | | |
| R10c-TEMPO + 2% | 26:18:18:38 | | 2.5 | | | 2 |
| Silica | | | | | | |
| R10c-TEMPO + 4% | 26:18:18:38 | | 2.5 | | | 4 |
| Silica | | | | | | |

The addition of impurities did impact mechanical properties of the polymer samples. With the inclusion of the compatibilizer, however, relatively low levels of impurities could be included with the base PO mixture without substantially adversely affecting the mechanical properties of the final polymer.

The additive “R10c-TEMPO (0.2 eq)” was reactively extruded in the mixture resin HOPE/PP (70/30 w/w) at weight loadings of ˜2.1% and ˜5% additive to form corresponding HOPE/PP compatibilizing copolymers (designated as COMP and COMP2, respectively) in the form of round filaments, which were then pelletized. These prepared COMP and COMP2 compatibilizing copolymers were used to compatibilize PP-contaminated HOPE (e.g., modeled as HOPE/PP 70/30 w/w) at various wt. % loadings of the compatibilizing copolymers (i.e., 4, 6, 8 and 26%) via melt blending of mixture resin and compatibilizer in extruder. For the sample with improved mechanical performance, the concentration of additive (R10c-TEMPO (0.2 eq)) in final compatibilized system remain below 0.5 wt %. Table 8 shows the mechanical properties of the compatibilized blends.

TABLE 8

| | Tensile Strength | Elongation at |
|---|---|---|
| Sample | at Break (MPa) | Break (%) |
| Neat-Blend | 13.9 | 245.5 |
| 4 wt % COMP-1 | 23.7 | 586.8 |
| 8 wt % COMP-1 | 23.6 | 581.5 |
| 4 wt % COMP-2 | 32.9 | 843.9 |
| ~6 wt % COMP-2 | 14.4 | 269.1 |
| ~26 wt % COMP-2 | 31.4 | 958.6 |

HDPE/PP compatibilizers were formed by a two-step process, starting with the preparation of modified HDPE (m-HDPE) and modified PP (m-PP). m-HDPE and m-PP were prepared by grafting diethylmaleate (DEM) as a grafting agent separately onto HDPE and PP by reactive extrusion. HDPE powder, diethylmaleate (1.67 mol % relative to (ethylene) repeat units in the HDPE), dicumyl peroxide (DCPO; 1 wt % relative to total polymer) as an initiator, and a TINUVIN 123 stabilizer (bis[2,2,6,6-tetramethyl-1-(octyloxy)piperidin-4-yl]decanedioate; 1 wt %) were blended to form a homogeneous mixture. The mixture was fed to an extruder, melted at 180° C., and compounded for 3 minutes. The molten mixture was then extruded as a macrofilament which was cut into pellets of m-HDPE. Pellets of m-PP were formed by a similar process, starting with PP powder instead of HDPE powder; the extruder was heated to 230° C. to melt the polymer mixture, but the process was otherwise identical to that used to prepare m-HDPE, including the amounts of additives.

HDPE/PP compatibilizers were then prepared by reactive extrusion of m-HDPE and m-PP with additives according to the recipes in Table 9. Equal amounts of m-HDPE and m-PP were mixed with a diol or diamine coupling agent (1,10-decanediol or p-phenylenediamine) and an antioxidant (octadecyl-3-(3,5-di-tert-butyl-4-hydroxyphenyl)propionate, available as IRGANOX 1076), fed to an extruder, melted at 230° C., and compounded for 3 minutes. The resulting molten mixtures were extruded as macrofilaments and cut into pellets to yield HDPE/PP compatibilizer pellets. As indicated in the table, the level of coupling agent was selected to provide an equivalent number of hydroxyl or amine groups based on the number of ester groups on the modified HDPE and PP resins, assuming 100% yield for the process of grafting diethylmaleate onto the HDPE and PP backbones as described above.

TABLE 9

| Sample ID | Description |
|---|---|
| COMP3b | m-HDPE & m-PP (1:1) + 1,10-decanediol (esters- |
| | equivalent hydroxyl groups) in the presence of |
| | 1 wt % antioxidant (semi-continuous extrusion) |
| COMP3e | m-HDPE & m-PP (1:1) + 1,10-decanediol (esters- |
| | equivalent hydroxyl groups) in the presence of |
| | 1 wt % antioxidant (continuous extrusion) |
| COMP4b | m-HDPE & m-PP (1:1) + p-phenylenediamine |
| | (esters-equivalent amine groups) in the presence |
| | of 1 wt % antioxidant (semi-continuous extrusion) |

The prepared compatibilizers were incorporated into HDPE/PP blends (70/30, 30/70, 20/80, 10/90 w/w) via melt extrusion. HDPE powder, PP powder, and compatibilizer (4 wt % loading based on total HDPE/PP content) were fed to an extruder, melted at 230° C. and compounded for 3 minutes. Specimens for mechanical property testing were prepared in dumbbell & rectangular shapes by injecting the molten mixture into a mold at 80° C. Specimens of HDPE, PP, and HDPE/PP without compatibilizer were also prepared via melt extrusion and injection molding.

TABLE 10

| | Tensile | Tensile | | | Izod |
|---|---|---|---|---|---|
| | Stress | Strength | | Elongation | Impact |
| | at Yield | at Break | Modulus | at Break | Strength |
| Sample | (MPa) | (MPa) | (MPa) | (%) | (kJ/m²) |
| HDPE | 31 | 18 | 340 | 170 | 12.1 |
| PP | 52 | 52 | 1100 | 520 | 3.8 |
| Neat HDPE/PP | | 29 | 510 | 710 | 5.8 |
| Blend (70/30) | | | | | |
| HDPE/PP Blend | | 36 | 600 | 850 | 6.0 |
| (70/30)-COMP3b | | | | | |
| (1%) | | | | | |
| HDPE/PP Blend | | 40 | 570 | 910 | 7.8 |
| (70/30)-COMP3b | | | | | |
| (2%) | | | | | |
| HDPE/PP Blend | | 38 | 570 | 860 | 6.0 |
| (70/30)-COMP3b | | | | | |
| (4%) | | | | | |

Table 10 shows mechanical properties of samples of neat HDPE, neat PP, neat 70:30 blend of HDPE/PE (“Neat Blend”), and 70:30 HDPE/PE extruded with 1%, 2% or 4% loading of the COMP3b additive composition. All compatibilized blends exhibited superior homogeneity, tensile strength at break, modulus, and elongation at break compared to the neat blend.

TABLE 11

| | Izod Impact |
|---|---|
| | Strength |
| Sample | (kJ/m²) |
| Neat HDPE/PP Blend (70/30) | 5.2 |
| HDPE/PP Blend (70/30)-COMP3b (4%) | 7.4 |
| HDPE/PP Blend (70/30)-COMP4b (4%) | 7.0 |
| HDPE/PP Blend (70/30)-COMM BM Yellow (4%) | 5.1 |
| HDPE/PP Blend (70/30)-COMM BM Brown (4%) | 4.2 |

Table 11 shows impact strength of samples of 70:30 HDPE/PE that were extruded with 4 wt % loading of one of two compatibilizers according the disclosure (including a diol (COMP3b) or diamine (COMP 4b) coupling agent) or a commercial benchmark (COMM BM). The samples containing a compatibilizer according to the disclosure exhibited higher impact strength than both the neat HDPE/PP blend and samples prepared using the commercial product.

TABLE 12

| | Tensile Stress | | Tensile Strength | | | | Elongation | | Izod Impact | |
|---|---|---|---|---|---|---|---|---|---|---|
| | at Yield (MPa) | | at Break (MPa) | | Modulus (MPa) | | at Break (%) | | Strength (kJ/m²) | |
| Sample | Neat | Comp. | Neat | Comp. | Neat | Comp. | Neat | Comp. | Neat | Comp. |
| HDPE | 27.9 | | 16.1 | | 392.1 | | 84.2 | | | |
| PP | 37.6 | | 30.2 | | 630.5 | | 432.0 | | 3.4 | |
| HDPE/PP | 30.2 | 30.9 | 22.0 | 29.5 | 456.1 | 473.7 | 478.7 | 551.7 | 5.2 | 7.2 |
| Blend (70/30) | | | | | | | | | | |
| HDPE/PP | 42.7 | 34.2 | 17.4 | 17.9 | 687.2 | 548.6 | 209.5 | 148.8 | 3.96 | 4.9 |
| Blend (30/70) | | | | | | | | | | |
| HDPE/PP | 34.1 | 34.1 | 18.8 | 16.7 | 627.7 | 545.3 | 146.5 | 216.0 | 3.8 | 4.6 |
| Blend (20/80) | | | | | | | | | | |
| HDPE/PP | 38.6 | 38.6 | 19.2 | 17.5 | 605.1 | 646.0 | 185.3 | 441.4 | 3.7 | 4.5 |
| Blend (10/90) | | | | | | | | | | |

Table 12 shows mechanical properties of samples of blends with varying HDPE/PP ratios, extruded without a compatibilizer (“Neat”) or with 4 wt % COMP3e (“Comp.”).

The addition of impurities did impact mechanical properties of the polymer samples. With the inclusion of the compatibilizer, however, relatively low levels of impurities could be included with the base PO mixture without substantially adversely affecting the mechanical properties of the final polymer.

### Example 4: Functionalized LLDPE

Linear-low density PE (LLDPE) was functionalized with a grafting agent via reactive extrusion (REX), both with and without a radical trapping agent. LLDPE is prone to crosslinking due to a large number of secondary carbons on the backbone (and to some extent, chain scission due to tertiary carbons). 2,2,6,6-Tetramethylpiperidin-1-yl)oxidanyl (TEMPO) binds reversibly with polymer radicals and was thus used here as a radical trapping agent to reduce the radical flux during the REX process. Reduced radical flux suppresses polymer radical coupling and subsequent crosslinking. LLDPE was REX processed in the presence and absence of TEMPO while keeping the concentration of dicumyl peroxide (initiator) and phenylene bismaleimide (PBA, grafting agent) the same. For comparison, neat LLDPE was also extruded in isolation. All samples underwent 3 min of REX processing at 180° C. and the polymer melts were injection molded into dumbbell-shaped specimens for subsequent tensile testing.

The control (non-functionalized) LLDPE sample had low tensile strength and high elongation due to the flexible nature of LLDPE. However, performing REX processing in the presence of a radical initiator and bismaleimide grafting agent, but without TEMPO radical trapping agent, led to a high intensity of undesirable crosslinking reaction, evident from a 56.2% increase in tensile strength and a drastic 80.4% decrease in the elongation. In contrast, in a sample with TEMPO content of 0.2 wt % (in addition to the radical initiator and bismaleimide grafting agent), tensile strength was only increased by 20.3%, while the elongation at break decreased by only ˜2.1% (from 592% for the LLDPE control to 578% for LLDPE with TEMPO). This suggests that the slow release of radicals during REX functionalization suppressed undesirable crosslinking.

To test the surface energy impact of the grafting agent, PBA and hexamethylene bismaleimide (HBA) were used as different grafting agents for LLDPE while keeping the concentration of TEMPO (0.07 wt %) and peroxide the same. Because PBA has a benzene ring with two maleimide units while HBA has an aliphatic C6 chain with two maleimide units, the surface energy of HBA should be lower than PBA as benzene has higher surface energy than a C6 aliphatic chain. Matching surface energy/solubility parameters of the grafting agents enables better mixing with LLDPE, which in turn, during the REX process, can prevent the crosslinking of radical LLDPE chains and thus promote the HBA grafting onto LLDPE. The sample with HBA grafting agent (i.e., a good surface energy match) showed essentially no/insignificant crosslinking as evidenced by an increase in tensile strength of only 3.1% as compared to a 20.6% increase for the sample with PBA grafting agent (i.e., a poor surface energy match). Similarly, for the sample with HBA, elongation at break increased by 1.6%, while the sample with PBA showed a significant decrease of 30.7%. The low 1.6% increase in elongation reveals suggests that there is essentially no/insignificant crosslinking, and second, the difunctional nature of HBA can increase the Mw, which in turn increases the elongation. This example illustrates the effectiveness of surface energy matching and slowing generation of free radicals for suppressing crosslinking.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. A method for functionalizing a carbon-carbon backbone (CCB) polymer, the method comprising:
reactive melt-processing a mixture comprising (i) a carbon-carbon backbone (CCB) polymer, (ii) a grafting agent selected from the group consisting of unsaturated cyclic anhydrides, unsaturated cyclic imides, ring-opened analogs thereof, and combinations thereof, (iii) an initiator, and (iv) optionally a reversible radical trapping agent, thereby forming a functionalized CCB polymer comprising the CCB polymer and the grafting agent;
wherein at least one of conditions (A), (B), and (C) apply:
(A) the grafting agent has a surface energy relative to that of the CCB polymer in a ratio in a range from 0.02 to 2.0;
(B) a ratio of a half-life of the initiator relative to a residence time for the reactive melt-processing is in a range of 0.2 to 5.0; or
(C) the radical trapping agent is present in the reactively melt-processed mixture.

2.-35. (canceled)

36. A method for forming a carbon-carbon backbone (CCB) compatibilizer copolymer, the method comprising:
(1) reactive melt-processing (i) a first carbon-carbon backbone (CCB) polymer, (ii) a first grafting agent selected from the group consisting of unsaturated cyclic anhydrides, unsaturated cyclic imides, ring-opened analogs thereof, and combinations thereof, (iii) a first initiator, and (iv) optionally a first reversible radical trapping agent, thereby forming a first functionalized CCB polymer comprising the first CCB polymer and the first grafting agent;
wherein at least one of conditions (A1), (B1), and (C1) apply:
(A1) the first grafting agent has a surface energy relative to that of the first CCB polymer in a ratio in a range from 0.02 to 2.0;
(B1) a ratio of a half-life of the first initiator relative to a residence time for the reactive melt-processing is in a range of 0.2 to 5.0; or
(C1) the first radical trapping agent is present;
(2) reactive melt-processing (i) a second polymer, (ii) a second grafting agent selected from the group consisting of unsaturated cyclic anhydrides, unsaturated cyclic imides, ring-opened analogs thereof, and combinations thereof, (iii) a second initiator, and (iv) optionally a second reversible radical trapping agent, thereby forming a second functionalized polymer comprising the second polymer and the second grafting agent;
wherein at least one of conditions (A2), (B2), and (C2) apply:
(A2) the second grafting agent has a surface energy relative to that of the second polymer in a ratio in a range from 0.02 to 2.0;
(B2) a ratio of a half-life of the second initiator relative to a residence time for the reactive melt-processing is in a range of 0.2 to 5.0; or
(C2) the second radical trapping agent is present; and
(3) reactive melt-processing the first functionalized CCB polymer and the second functionalized polymer, thereby forming a CCB compatibilizer copolymer comprising the first CCB polymer and the second polymer joined via the first grafting agent and the second grafting agent.

37. The method of claim 36, wherein:
the first grafting agent and the second grafting agent are monofunctional grafting agents;
the first functionalized CCB polymer and the second functionalized polymer are reactively melt-processed with a coupling agent; and
the CCB compatibilizer copolymer comprises coupling agent links between the first CCB polymer and the second polymer.

38. The method of claim 36, comprising: performing steps (1), (2), and (3) in a single melt-processing apparatus.

39. The method of claim 36, comprising: performing steps (1), (2), and (3) in two or more melt-processing apparatus.

40. The method of claim 36, wherein:
the second polymer is selected from the group consisting of high-density polyethylene (HDPE), low-density polyethylene (LDPE), linear low-density polyethylene (LLDPE), polypropylene (PP), polystyrene (PS), polyethylene terephthalate (PET), polylactic acid (PLA), polyamides, and combinations thereof; and
the second polymer is different from the CCB polymer.

41. The method of claim 36, wherein the second polymer comprises a second CCB polymer different from the first CCB polymer.

42. A method for compatibilizing a polymer blend, the method comprising:
forming a CCB compatibilizer copolymer according to the method of claim 36; and
melt-blending a mixture comprising a first polymer, a second polymer, and the CCB compatibilizer copolymer, thereby forming a compatibilized polymer blend;
wherein the first polymer and the second polymer correspond to segments of the CCB compatibilizer copolymer.

43. The method of claim 42, wherein:
the CCB compatibilizer copolymer is present in an amount in a range of 0.1 wt. % to 10 wt. % relative to the compatibilized polymer blend;
the first polymer is present in an amount in a range of 2 wt. % to 95 wt. % relative to the compatibilized polymer blend; and
the second polymer is present in an amount in a range of 2 wt. % to 95 wt. % relative to the compatibilized polymer blend.

44. The method of claim 42, wherein the first polymer and the second polymer are from a recycled polymer stream.

45. A method for compatibilizing a polymer blend, the method comprising:
providing a CCB compatibilizer copolymer formed according to the method of claim 36; and
melt-blending a mixture comprising a first polymer, a second polymer, and the CCB compatibilizer copolymer, thereby forming a compatibilized polymer blend;
wherein the first polymer and the second polymer correspond to segments of the CCB compatibilizer copolymer.

46. The method of claim 45, wherein:
the CCB compatibilizer copolymer is present in an amount in a range of 0.1 wt. % to 10 wt. % relative to the compatibilized polymer blend;
the first polymer is present in an amount in a range of 2 wt. % to 95 wt. % relative to the compatibilized polymer blend; and
the second polymer is present in an amount in a range of 2 wt. % to 95 wt. % relative to the compatibilized polymer blend.

47.-52. (canceled)

53. A functionalized carbon-carbon backbone (CCB) polymer comprising:
a free-radical-initiated reaction product between a (i) a carbon-carbon backbone (CCB) polymer and (ii) a grafting agent selected from the group consisting of unsaturated cyclic anhydrides, unsaturated cyclic imides, ring-opened analogs thereof, and combinations thereof.

54. A carbon-carbon backbone (CCB) compatibilizer copolymer comprising:
a free-radical-initiated reaction product between a (i) a carbon-carbon backbone (CCB) polymer, (ii) a further polymer, and (iii) a grafting agent selected from the group consisting of unsaturated cyclic anhydrides, unsaturated cyclic imides, ring-opened analogs thereof, and combinations thereof;
wherein the CCB compatibilizer copolymer comprises the CCB polymer and the further polymer joined via the grafting agent.
